(19) United States
(12) Patent Application Publication
(10) Pub. No.: US 2009/0162541 A1
(43) Pub. Date: Jun. 25, 2009

(54) NEAR-INFRARED-ABSORBING MATERIAL

(76) Inventors: Keizo Kimura, Kanagawa (JP); Osamu Uchida, Kanagawa (JP); Katsuyoshi Yamakawa, Kanagawa (JP)

Correspondence Address: BIRCH STEWART KOLASCH & BIRCH, PO BOX 747, FALLS CHURCH, VA, 22040-0747, US

(21) Appl. No.: 12/294,410

(22) PCT Filed: Feb. 1, 2007
(86) PCT No.: PCT/JP2007/052158

§ 371 Date: Sep. 24, 2008

(30) Foreign Application Priority Data
Mar. 24, 2006 (JP) 2006-084124

(51) Int. Cl. B05B 5/00

(52) U.S. Cl. 427/160

(57) ABSTRACT

The invention provides a near-infrared-absorbing material, comprising: at least two compounds having a maximum spectroscopic absorption wavelength in solution of 470 nm or less in a wavelength range of 270 to 1,600 nm; and a near-infrared-absorbing colorant compound obtained by oxidation of a compound represented by Formula (II):

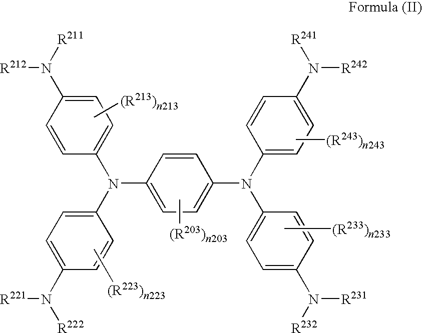

wherein, in Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R²⁴³ each independently represent a substituent group; and n²⁰³, n²¹³, n²²³, n²³³ and n²⁴³ each independently represent an integer of 0 to 4.

The disclosure of Japanese Patent Application No. 2006-084124 is incorporated by reference herein by reference in its entirety.

### TECHNICAL FIELD

The present invention relates to a near-infrared-absorbing material, in particular to a near-infrared-absorbing material superior both in light resistance and other physical properties, that plays an important role in optoelectronic applications such as near-infrared-absorbing filters, near-infrared-absorbing colored resin compositions, liquid crystal display elements, optical cards, optical recording media, and protective goggles.

### BACKGROUND ART

Near-infrared-absorbing colorants absorbing practically no visible light but absorbing infrared light have been used in various optoelectronic products such as near-infrared-absorbing filters. These colorants have occasionally had a problem of decomposition, when exposed to high temperature, high humidity or photoirradiation, according to the application thereof. Although naphthalocyanine colorants in specific structures, for example, are known to be effective in improving resistance to these conditions by modification of the structure of the colorant (see, for example, Japanese Patent Application Laid-Open (JP-A) Nos. 2-4635, 2-43269 and 2-338382), it has been difficult to improve the resistance and other physical properties such as absorption wavelength and solubility at the same time. Alternatively, methods of suppressing photodegradation by combined use of a near-infrared-absorbing colorant and an ultraviolet-absorbing material are known (see, for example, JP-A Nos. 11-167350, 2001-133624 and 2005-181966), none of these methods are sufficiently preventive and, thus, there exists a need for a method of further improving the light resistance.

### DISCLOSURE OF INVENTION

An object of the present invention is to provide a near-infrared-absorbing material superior both in light resistance and other physical properties that plays an important role in optoelectronic applications such as near-infrared-absorbing filters, near-infrared-absorbing colored resin compositions, liquid crystal display elements, optical cards, optical recording media, and protective goggles.

The present inventors extensively made a study of the near-infrared-absorbing material, and found that the above described object can be achieved by the following items <1> to <12>.

<1> A near-infrared-absorbing material, comprising: at least two compounds having a maximum spectroscopic absorption wavelength in solution of 470 nm or less in a wavelength range of 270 to 1,600 mm; and a near-infrared-absorbing colorant compound obtained by oxidation of a compound represented by Formula (II):

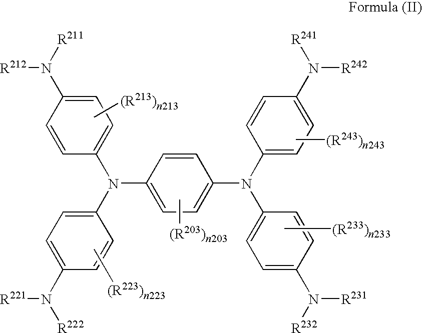

wherein, in Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R²⁴³ each independently represent a substituent group; and n²⁰³, n²¹³, n²²³, n²³³ and n²⁴³ each independently represent an integer of 0 to 4.

<2> The near-infrared-absorbing material of item <1>, wherein the maximum spectroscopic absorption wavelength is 430 nm or less.

<3> The near-infrared-absorbing material of item <2>, wherein the maximum spectroscopic absorption wavelength is 410 nm or less.

<4> The near-infrared-absorbing material of item <3>, wherein the maximum spectroscopic absorption wavelength is 380 nm or less.

<5> A near-infrared-absorbing material, comprising at least two ultraviolet-absorbing compounds and a near-infrared-absorbing colorant compound obtained by oxidation of a compound represented by the following Formula (II):

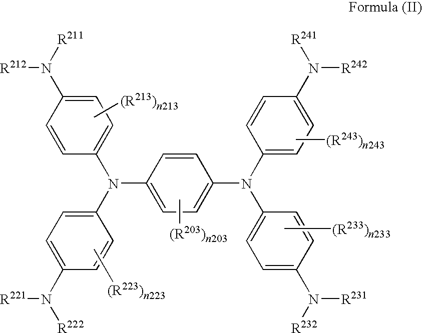

wherein, in Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R³⁴³ each independently represent a substituent group; and n²⁰³, n²¹³, n²²³, n²³³ and n²⁴³ each independently represent an integer of 0 to 4.

<6> The near-infrared-absorbing material of any one of items <1> to <5>, wherein the at least two compounds and the near-infrared-absorbing colorant compound are present in a single layer.

<7> The near-infrared-absorbing material of any one of items <1> to <6>, wherein the at least two compounds are two compounds different in structure selected from compounds represented by the following Formulae (I-1), (I-2), (I-3), (I-4) and (I-5):

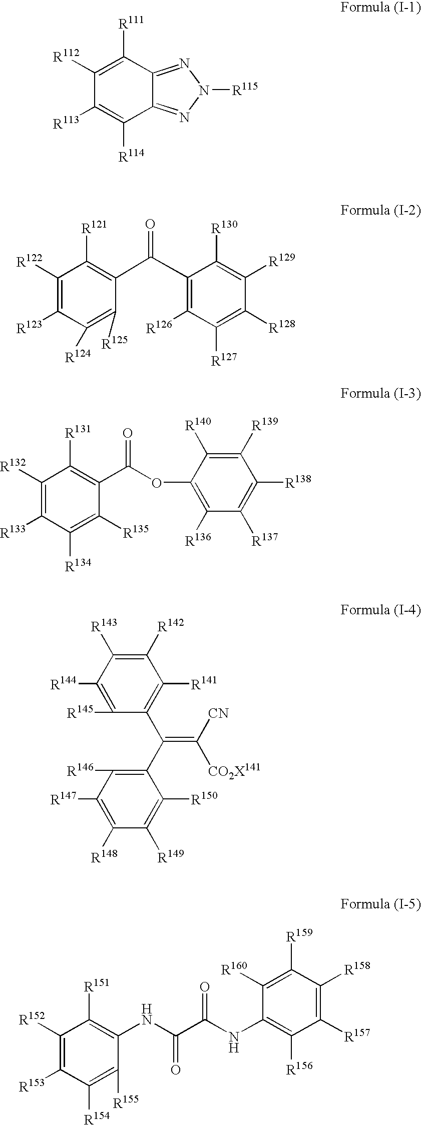

wherein R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ each independently represent a hydrogen atom or a substituent group; R¹¹⁵ represents a hydrogen atom, an aliphatic group, an aromatic group, or a heterocyclic group binding at its carbon atom; X¹⁴¹ represents a hydrogen atom, an aliphatic group, an aromatic group, or a heterocyclic group binding at its carbon atom; and among R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰, two neighboring substituent groups on a benzene ring in each Formula may bind to each other, forming a ring.

<8> The near-infrared-absorbing material of item <7>, wherein at least two compounds of the at least two compounds are compounds respectively selected from different formulae among Formulae (I-1), (I-2), (I-3), (I-4) and (I-5).

<9> The near-infrared-absorbing material of items <7> or <8>, wherein at least one compound of the at least two compounds is a compound represented by Formula (I-1).

<10> The near-infrared-absorbing material of any one of items <7> to <9>, wherein at least one compound of the at least two compounds is a compound represented by any one of Formulae (I-2), (I-3), (I-4) and (I-5).

<11> The near-infrared-absorbing material of any one of items <1> to <10>, wherein the total mole number of the at least two compounds is 0.1 mole or more with respect to 1 mole of the near-infrared-absorbing colorant compound.

<12> The near-infrared-absorbing material of any one of items <1> to <11>, wherein the near-infrared-absorbing colorant compound is a diimmonium salt represented by the following Formula (III-1).

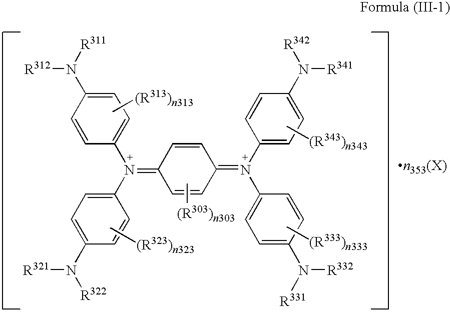

wherein, in Formula (III-1) R³¹¹, R³¹², R³²¹, R³²², R³³¹, R³³², R³⁴¹ and R³⁴² each independently represent a hydrogen atom or an aliphatic or aromatic group; R³⁰³, R³¹³, R³²³, R³³³ and R³⁴³ each independently represent a substituent group; and n³⁰³, n³¹³₃ n³²³, n³³³ ad n³⁴³ each independently represent an integer of 0 to 4; X represents a monovalent or divalent anion; n³⁵³ is 1 or 2; and the product of the valency of X and n³⁵³ is 2.

The invention provides a near-infrared-absorbing material superior both in light resistance and other physical properties that plays an important role in the field of optoelectronics such as infrared ray absorption filters, near-infrared ray absorption colored resin compositions, liquid crystal display elements, optical cards, optical recording media, and protective goggles.

### BEST MODE FOR CARRYING OUT THE INVENTION

Hereinafter, the invention will be described in detail with reference to embodiments.

The invention relates to a near-infrared-absorbing material, comprising: 1) at least two compounds having a maximum spectroscopic absorption wavelength in solution of 470 nm or less in a wavelength range of 270 to 1,600 nm; and 2) the near-infrared-absorbing colorant compound obtained by oxidation of a compound represented by Formula (II) below.

The aspect of containing these compounds is not particularly limited, and, for example, the at least two compounds having a maximum spectroscopic absorption wavelength in solution of 470 nm or less in a wavelength range of 270 to 1,600 nm and the near-infrared-absorbing colorant compound obtained by oxidation of a compound represented by Formula (II) may be present respectively in separate layers, or the at least two compounds having a maximum spectroscopic absorption wavelength in solution of 470 nm or less in a wavelength range of 270 to 1,600 nm and the near-infrared-absorbing colorant compound obtained by oxidation of a compound represented by Formula (II) may be present in the same single layer.

Among these aspects, preferable is the aspect in which these compounds are present in a single layer, for improving the light resistance of the near-infrared-absorbing colorant compound obtained by oxidation of a compound represented by Formula (II) by the at least two compounds having a maximum spectroscopic absorption wavelength in solution of 470 nm or less in a wavelength range of 270 to 1,600 nm.

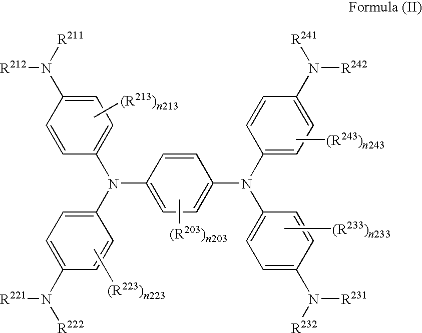

In Formula (I), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R²⁴³ each independently represent a substituent group; and n²⁰³₃ n¹³₃ n²²³, n²³³ and n²⁴³ each independently present an integer of 0 to 4.

<Maximum Spectroscopic Absorption Wavelength>

Hereinafter, the term maximum spectroscopic absorption wavelength will be described.

The maximum spectroscopic absorption wavelength is determined form an absorption spectrum in solution, and any solvent may be used, if the compound is soluble therein. The solvent may be an organic or inorganic solvent, or water, and the mixture thereof may also be used. The maximum spectroscopic absorption wavelength is in the range defined in the invention tinder any condition, if a solvent and a temperature at which the compound is soluble are used in the invention.

Examples of the organic solvents include amide-based solvents (such as N,N-dimethylformamide, N,N-dimethylacetamide, and 1-methyl-2-pyrrolidone), sulfone-based solvents (such as sulfolane), sulfoxide-based solvents (such as dimethylsulfoxide), ureide-based solvents (such as tetramethylurea), ether-based solvents (such as dioxane, tetrahydrofuran, and cyclopentylmethylether), ketone-based solvents (such as acetone and cyclohexanone), hydrocarbon-based solvents (such as toluene, xylene, and n-decane), halogenated solvents (such as tetrachloroethane, chlorobenzene, and chloronaphthalene), alcohol-based solvents (such as methanol, ethanol, isopropylalcohol, ethylene glycol, cyclohexanol, and phenol), pyridine-based solvents (such as pyridine, r-picoline, and 2,6-lutidine), ester-based solvents (such as ethyl butyrate and butyl acetate), carboxylic acid-based solvents (such as acetic acid and propionic acid), nitrile-based solvents (such as acetonitrile), sulfonic acid-based solvents (such as methanesulfonic acid), and amine-based solvents (such as triethylamine and tributylamine); and examples of the inorganic solvents include sulfuric acid and phosphoric acid.

Among these solvents, preferable are amide-based solvents, sulfone-based solvents, sulfoxide-based solvents, ureide-based solvents, ether-based solvents, ketone-based solvents, halogenated solvent, alcohol-based solvent, ester-based solvents, and nitrile-based solvents, and particularly preferable are ethyl acetate and N,N-dimethylformamide, at the maximum spectroscopic absorption wavelength of the compound defined in 1) above.

The concentration of the compound of which the maximum spectroscopic absorption wavelength is measured is not particularly limited, if it is a concentration allowing measurement of the maxim-am spectroscopic absorption wavelength, but preferably in the range of 1×10⁻¹³ to 1×10⁻⁷ (mol/l). The temperature is not particularly limited, but preferably 0° C. to 80° C. and most preferably room temperature (25° C.) if there is no problem in solubility of the compound.

The analyzer for use may be a common spectroscopic absorption analyzer (such as U-4100 spectrophotometer, manufactured by Hitachi High-Technologies Corporation).

On the other hand, the compound defined in 1) above is also an ultraviolet absorbent, and thus, the compound may be replaced with an ultraviolet absorbent.

<Groups in the Invention>

The groups in the invention will be described in detail, before the compound is described.

The aliphatic group in the present specification means an alkyl group, a substituted alkyl group, an alkenyl group, a substituted alkenyl group, an alkynyl group, a substituted alkynyl group, an aralkyl group or a substituted aralkyl group. The alkyl group may be a branched or cyclic group. The number of carbon atoms in the alkyl group is preferably 1 to 20, more preferably 1 to 18. The alkyl unit in the substituted alkyl group is the same as the above alkyl group. The alkenyl group may be a branched or cyclic ring. The number of carbon atoms in the alkenyl group is preferably 2 to 20, more preferably 2 to 18. The alkenyl unit in the substituted alkenyl group is the same as the alkenyl group above. The alkynyl group may be a branched or cyclic group. The number of carbon atoms in the alkynyl group is preferably 2 to 20, more preferably 2 to 18. The alkynyl unit in the substituted alkynyl group is the same as the alkynyl group above. The alkyl unit in the aralkyl group and substituted aralkyl group is the same as the alkyl group above. The aryl unit in the aralkyl group and substituted aralkyl group is the same as the aryl group below.

Examples of the substituent groups in the substituted alkyl group, substituted alkenyl group, or substituted alkynyl group, or in the alkyl unit in the substituted aralkyl group include halogen atoms (such as chlorine, bromine, and iodine); alkyl groups [straight-chain, branched, or cyclic substituted or unsubstituted alkyl group; specific examples thereof include alkyl groups (preferably alkyl groups having 1 to 30 carbon atoms, such as methyl, ethyl, n-propyl, isopropyl, t-butyl, n-octyl, eicosyl, 2-chloroethyl, 2-cyanoethyl, and 2-ethylhexyl), cycloalkyl groups (preferably substituted or unsubstituted cycloalkyl groups having 3 to 30 carbon atoms, such as cyclohexyl, cyclopentyl, and 4-n-dodecylcyclohexyl), bicycloalkyl groups (preferably substituted or unsubstituted bicycloalkyl groups having 5 to 30 carbon atoms, i.e., monovalent groups of bicycloalkanes having 5 to 30 carbon atoms from which a hydrogen atom is removed, such as bicyclo[1,2,2]heptan-2-yl and bicyclo[2,2,2]octan-3-yl), tricyclic structures having more ring structures, and the like; and the alkyl group in the substituent group described below (e.g., alkyl group in alkylthio group) is also the alkyl group in the same meaning]; alkenyl groups [straight-chain, branched, or cyclic substituted or unsubstituted alkenyl groups; alkenyl groups (including preferably substituted or unsubstituted alkenyl groups having 2 to 30 carbon atoms, such as vinyl, allyl, prenyl, geranyl, and oleyl), including cycloalkenyl groups (preferably, substituted or unsubstituted cycloalkenyl groups having 3 to 30 carbon atoms, i.e., monovalent groups of a cycloalkane having 3 to 30 carbon atoms from which a hydrogen atom is removed such as 2-cyclopenten-1-yl and 2-cyclohexen-1-yl), and bicycloalkenyl groups (substituted or unsubstituted bicycloalkenyl groups, preferably substituted or unsubstituted bicycloalkenyl groups having 5 to 30 carbon atoms, i.e., monovalent groups of a bicycloalkene having a double bond from which a hydrogen atom is removed, such as bicyclo[2,2,1]hept-2-en-1-yl and bicyclo[2,2,2]oct-2-en-4-yl)], alkynyl groups (preferably substituted or unsubstituted alkynyl groups having 2 to 30 carbon atoms, such as ethynyl, propargyl, and trimethylsilylethynyl),

aryl groups (preferably substituted or unsubstituted aryl groups having 6 to 30 carbon atoms, such as phenyl, p-toluoyl, naphthyl, m-chlorophenyl, and o-hexadecanoylaminophenyl), heterocyclic groups (monovalent groups, preferably five- or six-membered substituted or unsubstituted, aromatic or nonaromatic heterocyclic compounds from which a hydrogen atom is removed, more preferably, five- or six-membered heteroaromatic ring groups having 3 to 30 carbon atoms, such as 2-furyl, 2-thienyl, 2-pyridinyl, and 2-benzothiazolyl), a cyano group, a hydroxyl group, a nitro group, a carboxyl group, alkoxy groups (preferably substituted or unsubstituted alkoxy groups having 1 to 30 carbon atoms, such as methoxy, ethoxy, isopropoxy, t-butoxy, n-octyloxy, and 2-methoxyethoxy), aryloxy groups (preferably substituted or unsubstituted aryloxy groups having 6 to 30 carbon atoms, such as phenoxy, 2-methylphenoxy, 4-t-butylphenoxy, 3-nitrophenoxy, and 2-tetradecanoylaminophenoxy), silyloxy groups (preferably silyloxy groups having 3 to 20 carbon atoms, such as trimethylsilyloxy and t-butyldimethylsilyloxy), heterocyclic oxy groups (preferably substituted or unsubstituted heterocyclic oxy groups having 2 to 30 carbon atoms, such as 1-phenyltetrazole-5-oxy and 2-tetrahydropyranyloxy), acyloxy groups (preferably formyloxy group, substituted or unsubstituted alkylcarbonyloxy groups having 2 to 30 carbon atoms, and substituted or unsubstituted arylcarbonyloxy groups having 6 to 30 carbon atoms, such as formyloxy, acetyloxy, pivaloyloxy, stearoyloxy, benzoyloxy, and p-methoxyphenylcarbonyloxy), carbamoyloxy groups (preferably substituted or unsubstituted carbamoyloxy group having 1 to 30 carbon atoms, such as N,N-dimethylcarbamoyloxy, N,N-diethylcarbamoyloxy, morpholinocarbonyloxy, N,N-di-n-octylaminocarbonyloxy, and N-n-octylcarbamoyloxy), alkoxycarbonyloxy groups (preferably substituted or unsubstituted alkoxycarbonyloxy groups having 2 to 30 carbon atoms, such as methoxycarbonyloxy, ethoxycarbonyloxy, t-butoxycarbonyloxy, and n-octylcarbonyloxy), aryloxycarbonyloxy groups (preferably substituted or unsubstituted aryloxycarbonyloxy group having 7 to 30 carbon atoms, such as phenoxycarbonyloxy, p-methoxyphenoxycarbonyloxy, and p-n-hexadecyloxyphenoxycarbonyloxy), amino groups (preferably an amino group, substituted or unsubstituted alkylamino groups having 1 to 30 carbon atoms, and substituted or unsubstituted anilino groups having 6 to 30 carbon atoms, such as amino, methylamino, dimethylamino, anilino, N-ii-ethyl-anilino, and diphenylamino), acylamino groups (preferably a formylamino group, substituted or unsubstituted alkylcarbonylamino groups having 1 to 30 carbon atoms, and substituted or unsubstituted arylcarbonylamino group having 6 to 30 carbon atoms, such as formylamino, acetylamino, pivaloylamino, lauroylamino, benzoylamino, and 3,4,5-tri-n-octyloxyphenylcarbonylamino), aminocarbonylamino groups (preferably substituted or unsubstituted aminocarbonylamino groups having 1 to 30 carbon atoms, such as carbamoylamino, N,N-dimethylaminocarbonylamino, N,N-diethylaminocarbonylamino, and morpholinocarbonylamino), alkoxycarbonylamino groups (preferably substituted or unsubstituted alkoxycarbonylamino groups having 2 to 30 carbon atoms, such as methoxycarbonylamino, ethoxycarbonylamino, t-butoxycarbonylamino, n-octadecyloxycarbonylamino, and N-methyl-methoxycarbonylamino)₃, aryloxycarbonylamino groups (preferably, substituted or unsubstituted aryloxycarbonylamino groups having 7 to 30 carbon atoms, such as phenoxycarbonylamino, p-chlorophenoxycarbonylamino, and m-n-octyloxyphenoxycarbonylamino), sulfamoylamino groups (preferably substituted or unsubstituted sulfamoylamino group having 0 to 30 carbon atoms, such as sulfamoylamino, N,N-dimethylaminosulfonylamino, and N-n-octylaminosulfonylamino), alkyl and arylsulfonylamino groups (preferably substituted or unsubstituted alkylsulfonylamino groups having 1 to 30 carbon atoms and substituted or unsubstituted arylsulfonylamino groups having 6 to 30 carbon atoms, such as methylsulfonylamino, butylsulfonylamino, phenylsulfonylamino, 2,3,5-trichlorophenylsulfonylamino, and p-methylphenylsulfonylamino), a mercapto group, alkylthio groups (preferably substituted or unsubstituted alkylthio group having 1 to 30 carbon atoms, such as methylthio, ethylthio, and n-hexadecylthio), arylthio groups preferably substituted or unsubstituted arylthio groups having 6 to 30 carbon atoms, such as phenylthio, p-chlorophenylthio, and m-methoxyphenylthio), heterocyclic thio groups (preferably substituted or unsubstituted heterocyclic thio groups having 2 to 30 carbon atoms, such as 2-benzothiazolylthio and 1-phenyltetrazol-5-ylthio), sulfamoyl groups (preferably substituted or unsubstituted sulfamoyl groups having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl, and N—(N′-pheylcarbamoyl)sulfamoyl), a sulfo group, alkyl- or aryl-sulfinyl groups (preferably, substituted or unsubstituted alkylsulfinyl groups having 1 to 30 carbon atoms and substituted or unsubstituted arylsulfinyl group having 6 to 30 carbon atoms, such as methylsulfinyl, ethylsulfinyl, phenylsulfinyl, and p-methylphenylsulfinyl),

alkyl or arylsulfonyl groups (preferably substituted or unsubstituted alkylsulfonyl groups having 1 to 30 carbon atoms and substituted or unsubstituted arylsulfonyl groups having 6 to 30 carbon atoms, such as methylsulfonyl, ethylsulfonyl, phenylsulfonyl, and p-methylphenylsulfonyl), acyl groups (preferably a formyl group, substituted or unsubstituted alkylcarbonyl groups having 2 to 30 carbon atoms, substituted or unsubstituted aryloxycarbonyl groups having 7 to 30 carbon atoms, and heterocyclic carbonyl groups having a carbonyl group bound to a substituted or unsubstituted carbon group having 4 to 30 carbon atoms, such as acetyl, pivaloyl, 2-chloroacetyl, stearoyl, benzoyl, p-n-octyloxyphenylcarbonyl, 2-pyridylcarbonyl, and 2-furylcarbonyl), aryloxycarbonyl groups (preferably substituted or unsubstituted aryloxycarbonyl groups having 7 to 30 carbon atoms, such as phenoxycarbonyl, o-chlorophenoxycarbonyl, m-nitrophenoxycarbonyl, and p-t-butylphenoxycarbonyl), alkoxycarbonyl groups (preferably substituted or unsubstituted alkoxycarbonyl groups having 2 to 30 carbon atoms, such as methoxycarbonyl, ethoxycarbonyl, t-butoxycarbonyl, and n-octadecyloxycarbonyl), carbamoyl groups (preferably substituted or unsubstituted carbamoyl groups having 1 to 30 carbon atoms, such as carbamoyl, N-methylcarbamoyl, N,N-dimethylcarbamoyl, N,N-di-n-octylcarbamoyl, and N-(methylsulfonyl)carbamoyl),

aryl or heterocyclic azo groups (preferably substituted or unsubstituted aryl azo groups having 6 to 30 carbon atoms and substituted or unsubstituted heterocyclic azo groups having 3 to 30 carbon atoms, such as phenylazo, p-chlorophenylazo, and 5-ethylthio-1,3,4-thiadiazol-2-ylazo), imido groups (preferably, N-succinimido and N-phthalimido), phosphino groups (preferably substituted or unsubstituted phosphino groups having 2 to 30 carbon atoms, such as dimethylphosphino, diphenylphosphino, and methylphenoxyphosphino), phosphinyl groups (preferably substituted or unsubstituted phosphinyl groups having 2 to 30 carbon atoms, such as phosphinyl, dioctyloxyphosphinyl, and diethoxyphosphinyl), phosphinyloxy groups (preferably substituted or unsubstituted phosphinyloxy groups having 2 to 30 carbon atoms, such as diphenoxyphosphinyloxy and dioctyloxyphosphinyloxy), phosphinylamino groups (preferably substituted or unsubstituted phosphinylamino groups having 2 to 30 carbon atoms, such as dimethoxyphosphinylamino and dimethylaminophosphinylamino), silyl groups (preferably substituted or unsubstituted silyl groups having 3 to 30 carbon atoms, such as trimethylsilyl, t-butyldimethylsilyl, and phenyldimethylsilyl), and the like.

The functional groups above containing hydrogen atoms may be removed of its hydrogen atoms and substituted with one of the groups above. Examples of the functional groups include alkylcarbonylaminosulfonyl groups, arylcarbonylaminosulfonyl groups, alkylsulfonylaminocarbonyl groups, and arylsulfonylaminocarbonyl groups. Specific examples thereof include groups such as methylsulfonylaminocarbonyl, p-methylphenylsulfonylaminocarbonyl, acetylaminosulfonyl, and benzoylaminosulfonyl.

Substituent groups to the aryl unit in the substituted aralkyl group include the substituent groups to the following substituted aryl group.

The aromatic group in the present specification means an aryl group or a substituted aryl group. These aromatic groups may be fused with an aliphatic ring, another aromatic ring or a hetero ring. The number of carbon atoms in the aromatic group is preferably 6 to 40, more preferably, 5 to 30, and still more preferably 6 to 20. Among them, the aryl group is particularly preferably a phenyl or naphthyl group that may have substituent, particularly preferably a phenyl group that may have substituent.

Examples of the substituent groups of the substituted aryl group include those described as the “substituent groups of the alkyl unit in the substituted alkyl group, substituted alkenyl group, substituted alkynyl group, and of substituted aralkyl group” described above.

The heterocyclic group in the present specification contains at least one heteroatom as a ring atom, and the ring may be saturated or unsaturated, aromatic or non-aromatic, and fused or unfused with another ring forming a fused ring, and also, may have substituent. The ring is preferably a four- to eight-membered ring.

In the invention, an aromatic five- or six-membered saturated or unsaturated heterocyclic ring is preferably contained. The heterocyclic ring may be fused with an aliphatic or aromatic ring or another heterocyclic ring. The heteroatom in the heterocyclic ring is preferably B, N, O, S, Se or Te. Among them, the heteroatom in the heterocyclic ring is preferably N, O or S. The heterocyclic ring is preferably a monovalent group having a free carbon atom (the heterocyclic group binds at the carbon atom). The number of carbon atoms in the heterocyclic group is preferably 1 to 40, more preferably 1 to 30, and still more preferably 1 to 20. Examples of the saturated heterocyclic rings include pyrrolidine ring, morpholine ring, 2-bora-1,3-dioxolane ring and 1,3-thiazolidine ring. Examples of the unsaturated heterocyclic rings include imidazole ring, thiazole ring, benzothiazole ring, benzoxazole ring, benzotriazole ring, benzoselenazole ring, pyridine ring, pyrimidine ring and quinoline ring. The heterocyclic group may have substituent, and examples of the substituent groups include the “substituents of the alkyl unit in the substituted alkyl group, substituted alkenyl group, substituted alkynyl group, and substituted aralkyl group”.

<Compound Having a Maximum Spectroscopic Absorption Wavelength in Solution of 470 nm or Less in a Wavelength Range of 270 to 1,600 nm, or Ultraviolet Absorbent>

The maximum spectroscopic absorption wavelength of the compound in solution is preferably 430 nm or less, more preferably 410=n or less, and still more preferably 380 inn or less, from the viewpoint of spectroscopic absorption characteristics of the compound.

On the other hand, examples of the compounds preferable from the viewpoint of “ultraviolet absorbent” or the spectroscopic absorption characteristics include benzotriazole compounds, benzophenone compounds, cinnamic acid compounds, thiazolidone compounds, 1,3-butadiene compounds, salicylic ester compounds, dianilide oxalate compounds, and the like. Examples of these compounds include those described in Japanese Patent Application Publication (JP-B) No. 44-29627 and JP-A No. 51-56620.

Preferable among them are benzotriazole compounds, benzophenone compounds, cinnamic acid compounds, salicylic ester compounds and dianilide oxalate compounds: more preferable are benzotriazole compounds, benzophenone compounds, cinnamic acid compounds and salicylic ester compounds; still more preferable are benzotriazole compounds, benzophenone compounds and salicylic ester compounds; still more preferable are benzotriazole compounds and benzophenone compounds; and benzotriazole compounds are most preferable. In the invention, at least two of these compounds are used; and preferably, one is a benzotriazole compound, and the other is a compound selected from the benzophenone, cinnamic acid, salicylic ester, and dianilide oxalate compounds.

Compounds preferable as the “compound having a maximum spectroscopic absorption wavelength in solution of 470 nm or less in a wavelength range of 270 to 1,600 nm” or the “ultraviolet absorbent” are represented by the following Formula (I-1) to (I-5).

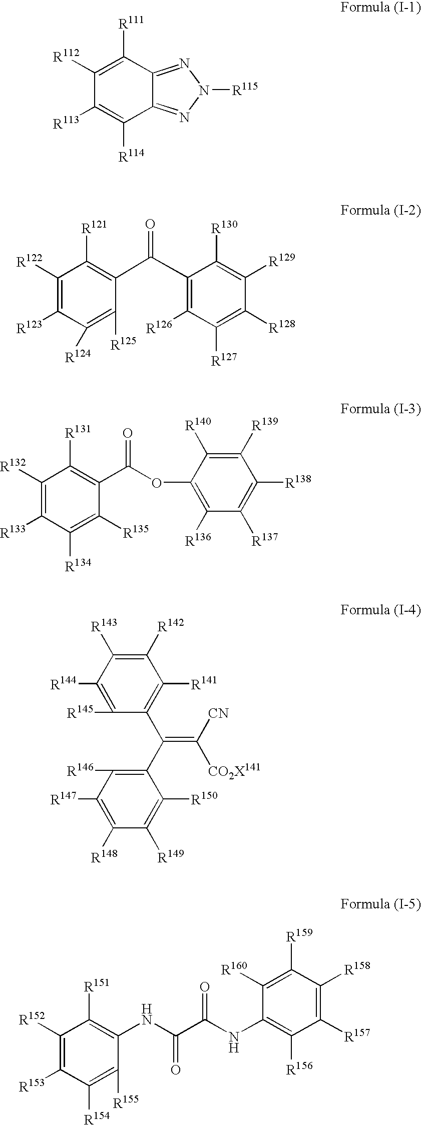

In the Formulae, R¹¹¹ to R¹¹⁴, R¹²¹ to R¹³⁰, R¹³¹ to R¹⁴⁰, R¹⁴¹ to R¹⁵⁰₃ and 151 to R¹⁶⁰ each independently represent a hydrogen atom or a substituent group; R¹¹⁵ represents a hydrogen atom, an aliphatic group, an aromatic group or a heterocyclic group binding at its carbon atom; and X¹⁴¹ represents a hydrogen atom, an aliphatic group, an aromatic group or a heterocyclic group binding at its carbon atom.

Neighboring groups among benzene ring substituents R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ in each Formula may bind to each other, forming a ring.

Examples of the substituent groups represented by R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ include the “substituents of the alkyl unit in the substituted alkyl group, substituted alkenyl group, substituted alkynyl group, or substituted aralkyl group” described above.

Preferable examples of the R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ include hydrogen and halogen atoms and alkyl, alkenyl, alkynyl, aryl, cyano, hydroxyl, carboxyl, alkoxy, aryloxy, silyloxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl or arylsulfonylamino, mercapto, alkylthio, arylthio, sulfamoyl, sulfo, alkyl- or aryl-sulfinyl, alkyl- or aryl-sulfonyl, acyl, aryloxycarbonyl, alkoxycarbonyl, carbamoyl, imido, phosphino, phosphinyl, phosphinyloxy, phosphinylamino, and silyl groups.

More preferably, each of R¹¹¹ to R¹¹⁴ represents a hydrogen or halogen atom or an alkyl, alkenyl, aryl, cyano, hydroxyl, carboxyl, alkoxy, aryloxy, silyloxy, amino, alkylthio, arylthio, imido, or silyl group; more preferably a hydrogen or halogen atom or an alkyl, aryl, alkoxy, aryloxy, silyloxy, or amino group; and still more preferably a hydrogen or halogen atom or an alkyl; and most preferably a hydrogen or halogen atom.

More preferably, each of R¹²¹ to R¹³⁰ represents a hydrogen or halogen atom or an alkyl, alkenyl, aryl group, cyano, hydroxyl, carboxyl, alkoxy, aryloxy, silyloxy, acyloxy, acylamino, aminocarbonylamino, alkoxycarbonylamino, aryloxycarbonylamino, sulfamoylamino, alkyl or arylsulfonylamino, mercapto, alkylthio, arylthio, sulfamoyl, sulfo, alkyl- or aryl-sulfonyl, acyl, aryloxycarbonyl, alkoxycarbonyl, carbamoyl, imide, or silyl group; more preferably a hydrogen or halogen atom or an alkyl, aryl, hydroxyl, alkoxy, aryloxy, acyloxy, acylamino, alkyl- or aryl-sulfonylamino, sulfamoyl, acyl, aryloxycarbonyl, alkoxycarbonyl, or carbamoyl group; still more preferably a hydrogen or halogen atom or an alkyl, hydroxyl, alkoxy, acyloxy, acylamino, acyl, alkoxycarbonyl, or carbamoyl group; and still more preferably a hydrogen or halogen atom or an alkyl, hydroxyl, alkoxy, acylamino, or alkoxycarbonyl group. R¹²¹ most preferably represents a hydroxy group.

More preferably, each of R¹³¹ to R¹⁴⁰ represents a hydrogen or halogen atom or an alkyl, alkenyl, aryl, cyano, hydroxyl, carboxyl, alkoxy, aryloxy, silyloxy, acyloxy, acylamino, aminocarbonylamino, alkoxycarbonylamino, aryloxycarbonylamino, sulfamoylamino, alkyl- or aryl-sulfonylamino, mercapto, alkylthio, arylthio, sulfamoyl, sulfo, alkyl- or aryl-sulfonyl, acyl, aryloxycarbonyl, alkoxycarbonyl, carbamoyl, imide, or silyl group;

more preferably a hydrogen or halogen atom or an alkyl, aryl, hydroxyl, alkoxy, aryloxy, acyloxy, acylamino, alkyl- or aryl-sulfonylamino, sulfamoyl, acyl, aryloxycarbonyl, alkoxycarbonyl, or carbamoyl group; still more preferably a hydrogen or halogen atom or an alkyl, hydroxyl, alkoxy, acyloxy, acylamino, acyl, alkoxycarbonyl, or carbamoyl group; and still more preferably a hydrogen or halogen atom or an alkyl, hydroxyl, alkoxy, acylamino, or alkoxycarbonyl group. R¹³¹ most preferably represents a hydroxy group.

More preferably, each of R¹⁴¹ to R¹⁵⁰ represents a hydrogen or halogen atom or an alkyl, aryl, hydroxyl, alkoxy, aryloxy, silyloxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl- or aryl-sulfonylamino, alkylthio, arylthio, sulfamoyl, acyl, aryloxycarbonyl, alkoxycarbonyl, carbamoyl, or silyl group; more preferably a hydrogen or halogen atom or an alkyl, aryl, alkoxy, aryloxy, amino, acylamino, alkylthio, or arylthio group; still more preferably a hydrogen or halogen atom or an alkyl, alkoxy, amino, or acylamino group; and most preferably a hydrogen atom or an alkoxy or amino group.

More preferably, each of R¹⁵¹ to R¹⁶⁰ represents a hydrogen or halogen atom or alkyl, aryl, cyano, hydroxyl, alkoxy, aryloxy, acyloxy, amino, acylamino, mercapto, alkylthio, arylthio, sulfamoyl, alkyl- or aryl-sulfinyl, alkyl- or aryl-sulfonyl, acyl, aryloxycarbonyl, alkoxycarbonyl, or silyl group; and more preferably a hydrogen or halogen atom or an alkyl, aryl, hydroxyl, alkoxy, acyloxy, amino, acylamino, arylthio, acyl, aryloxycarbonyl, or alkoxycarbonyl group.

R¹¹⁵ represents a hydrogen atom or an aliphatic, aromatic or heterocyclic group binding at its carbon atom; preferably a hydrogen atom or an alkyl, alkenyl, alkynyl, or aryl group; more preferably a hydrogen atom or an alkyl group having 1 to 30 carbon atoms, an alkenyl group having 2 to 30 carbon atoms, an alkynyl group having 2 to 30 carbon atoms, or an aryl group having 6 to 30 carbon atoms; still more preferably a hydrogen atom or an alkyl group having 1 to 25 carbon atoms, an alkenyl group having 2 to 25 carbon atoms, or an aryl group having 6 to 25 carbon atoms; still more preferably an carbon alkyl group having 1 to 22 carbon atoms or an aryl group having 6 to 22 carbon atoms; still more preferably an aryl group having 6 to 20 carbon atoms; and most preferably an ortho-hydroxyphenyl group having 6 to 20 carbon atoms.

X¹⁴¹ represents a hydrogen atom, an aliphatic, an aromatic group or a heterocyclic group binding at its carbon atom; preferably a hydrogen atom or an alkyl, alkenyl, alkynyl, or aryl group; more preferably a hydrogen atom, an alkyl group having 1 to 30 carbon atoms, an alkenyl group having 2 to 30 carbon atoms, an alkynyl group having 2 to 30 carbon atoms, or an aryl group having 6 to 30 carbon atoms; more preferably a hydrogen atom, an alkyl group having 1 to 25 carbon atoms, an alkenyl group having 2 to 25 carbon atoms, or an aryl group having 6 to 25 carbon atoms; still more preferably an alkyl group having 1 to 22 carbon atoms or an aryl group having 6 to 22 carbon atoms; and most preferably an alkyl group having 1 to 18 carbon atoms.

Preferably among these compounds, at least two compounds represented by the Formulae above are selected, and more preferably, at least two compounds respectively represented by different Formulae (I-1) to (I-5) are selected.

Preferably, at least one is a compound represented by Formula (I-1) or a compound represented by one of the Formulae (I-2) to (I-5), and more preferably, at least one is a compound represented by Formula (I-1).

Hereinafter, specific examples of the “compounds having a maximum spectroscopic absorption wavelength of 470 non or less in the wavelength range of 270 to 1,600 nm in solution” or the “ultraviolet absorbents” are listed below, however the invention is not limited thereto.

(Compounds Included in Formula (I-1))

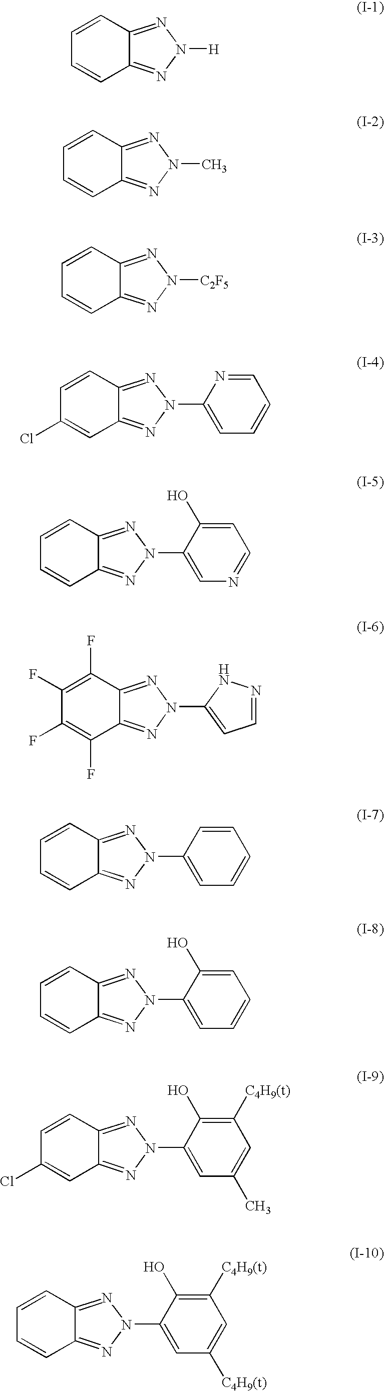

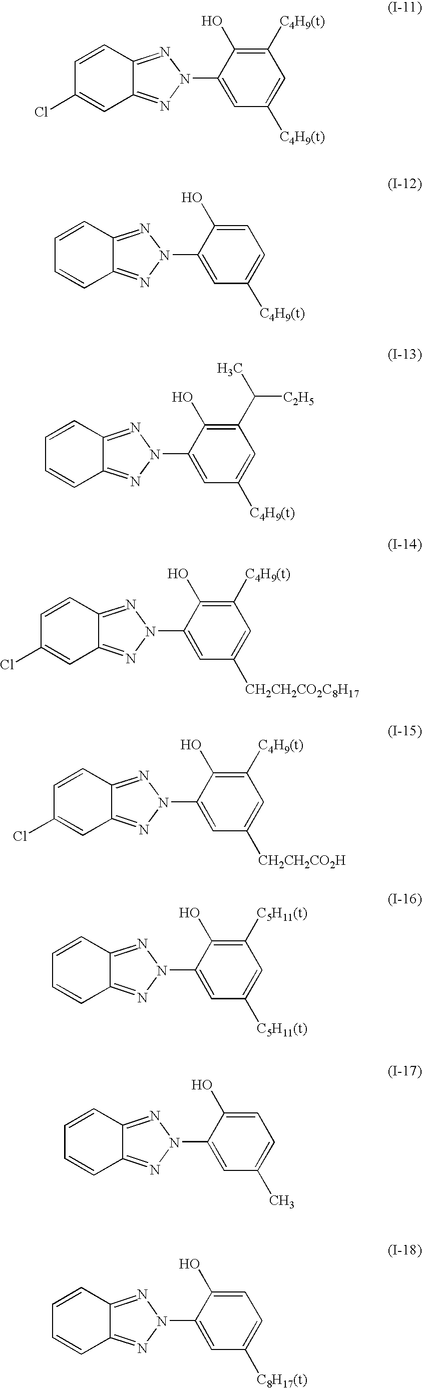

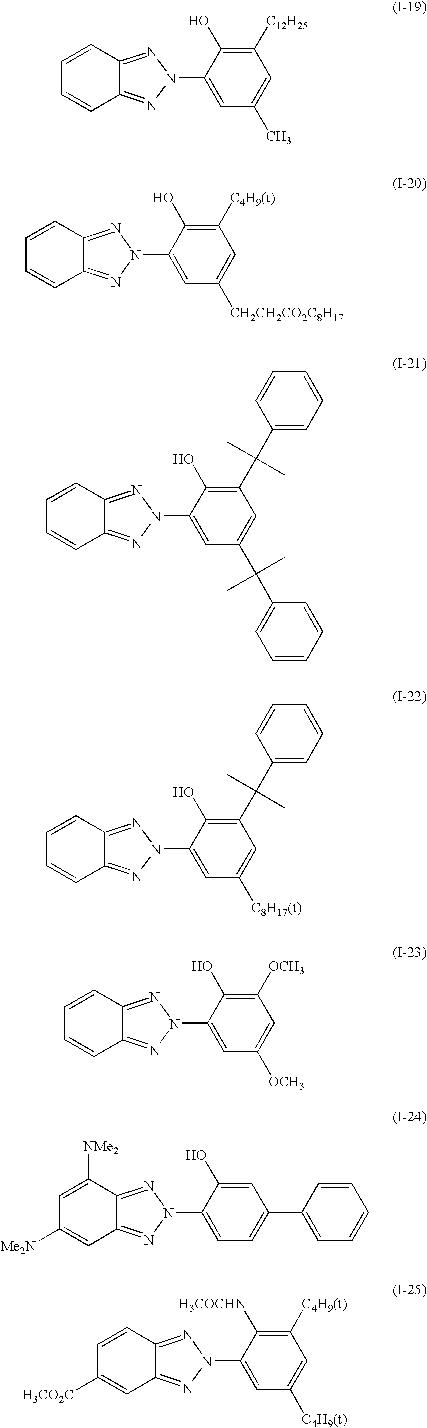

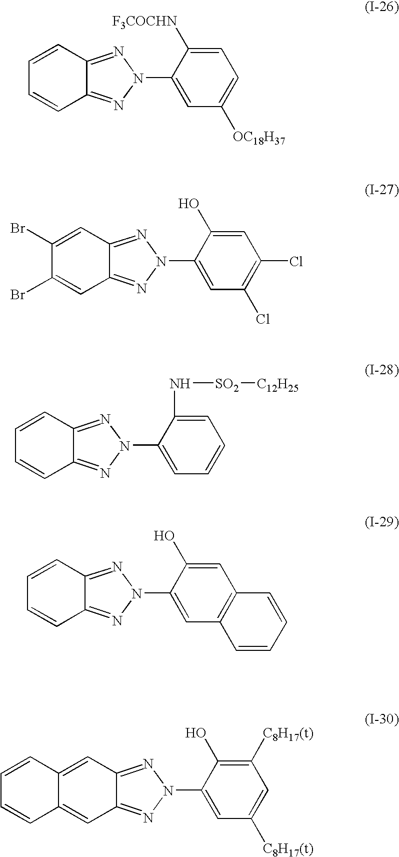

(Compounds Included in Formula (I-2))

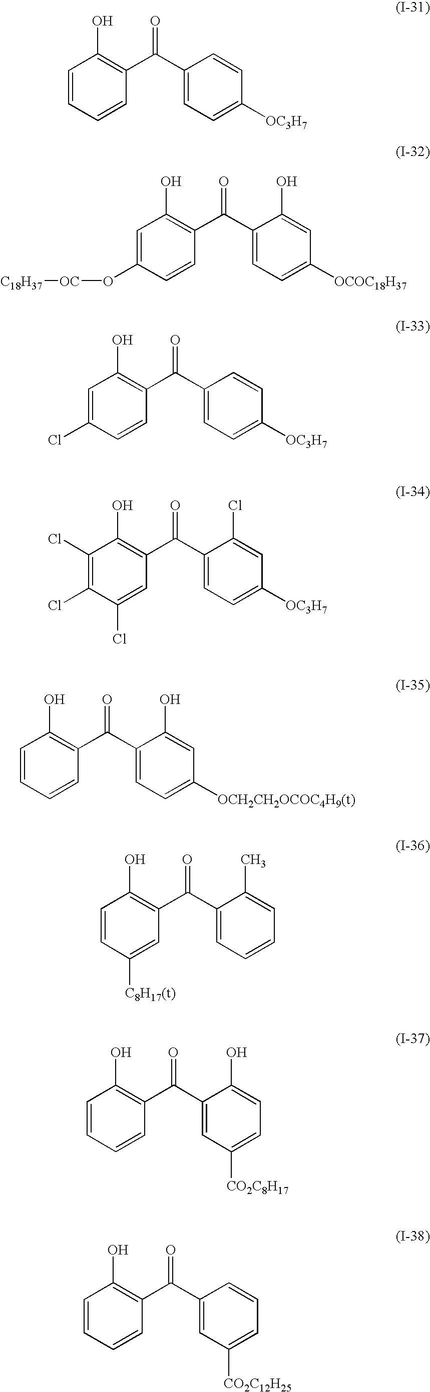

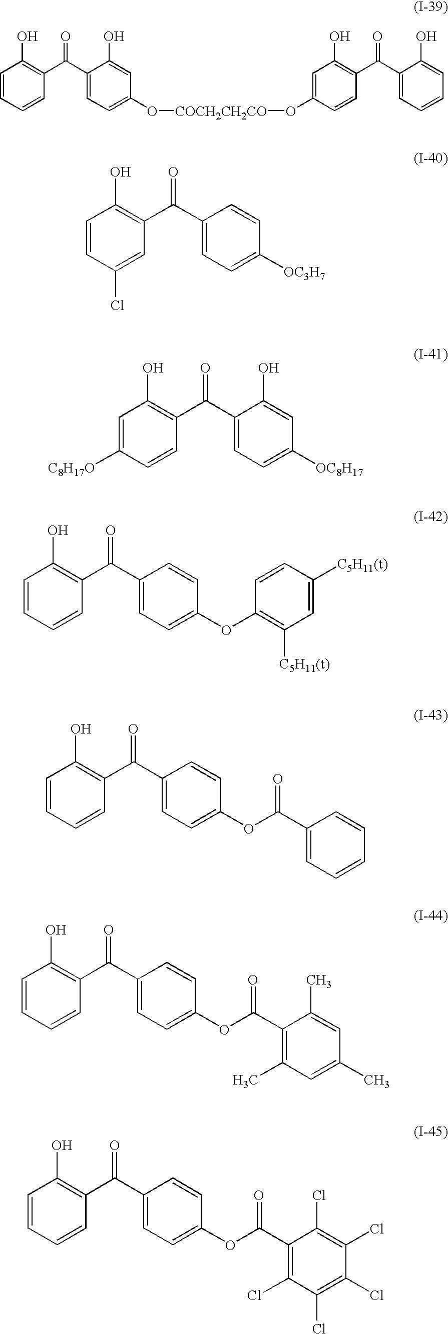

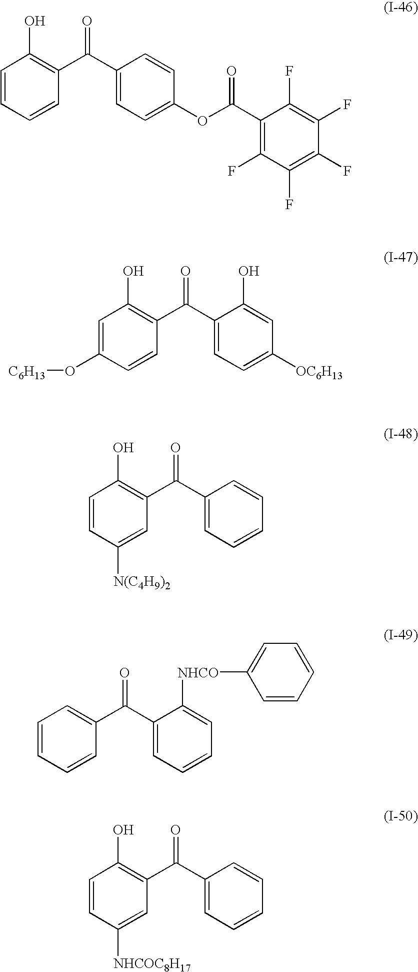

(Compounds Included in Formula (I-3))

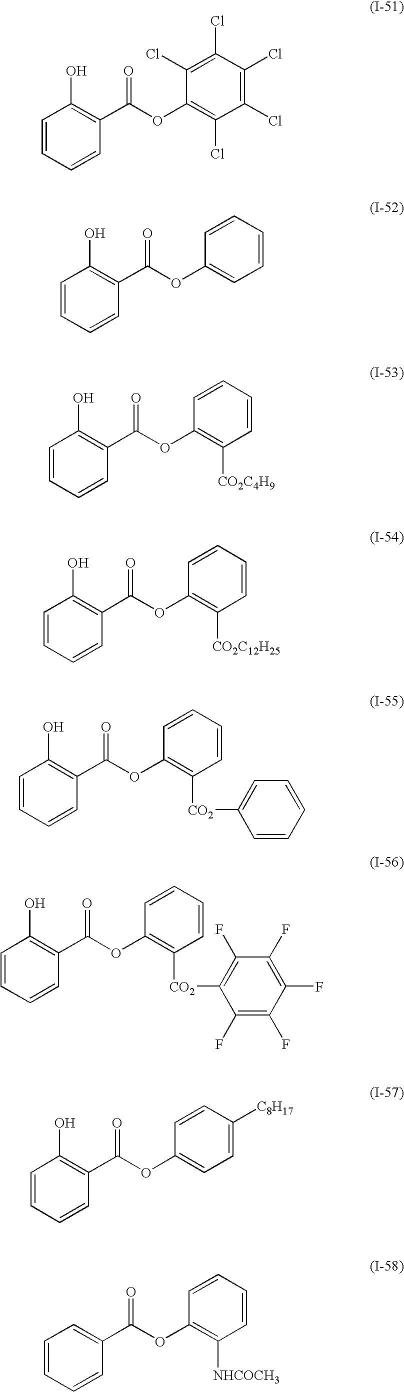

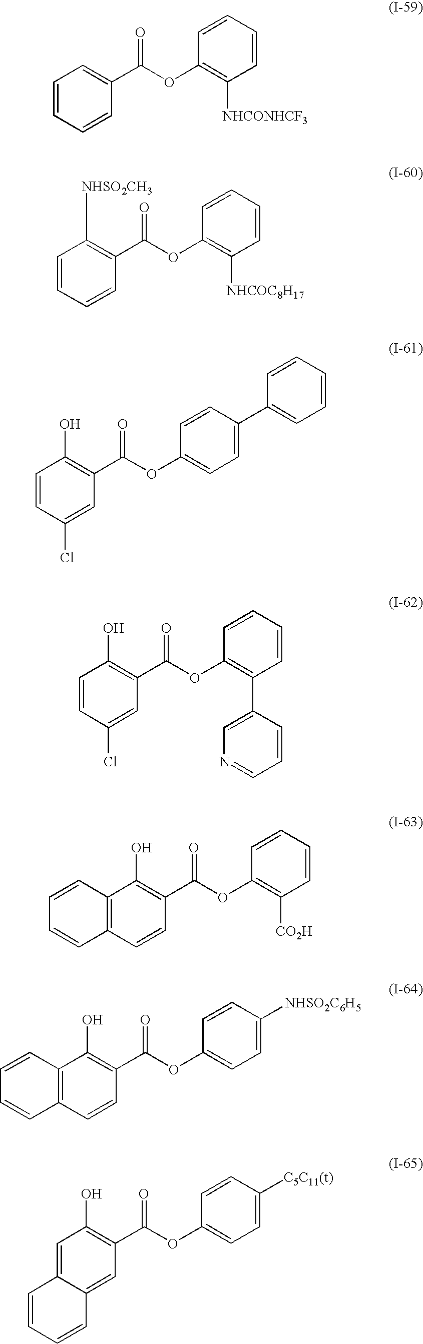

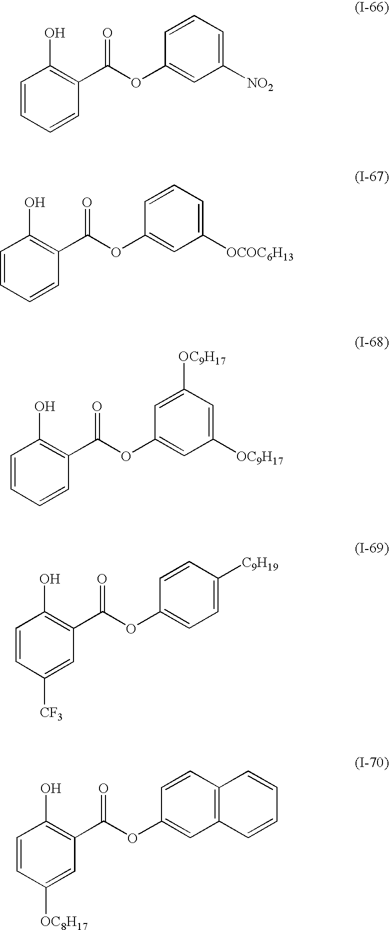

(Compounds Included in Formula (I-4))

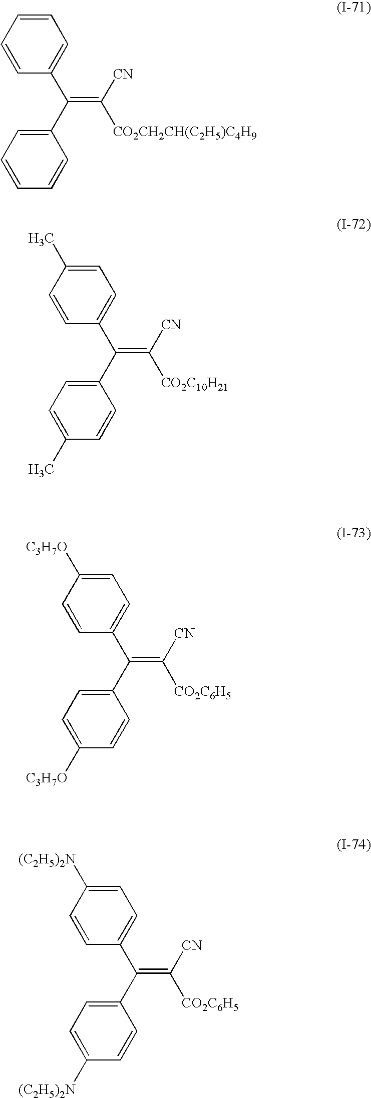

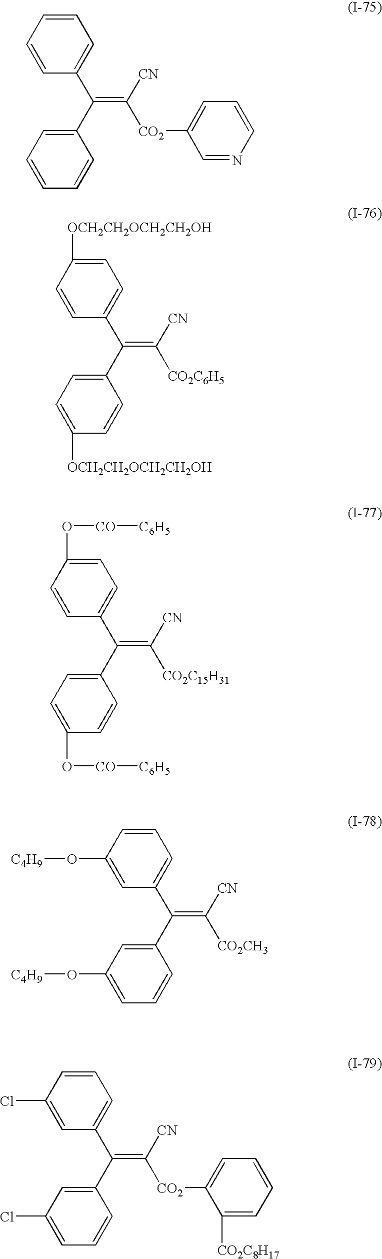

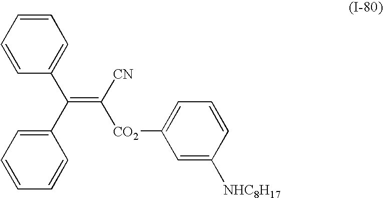

(Compounds Included in Formula (I-5))

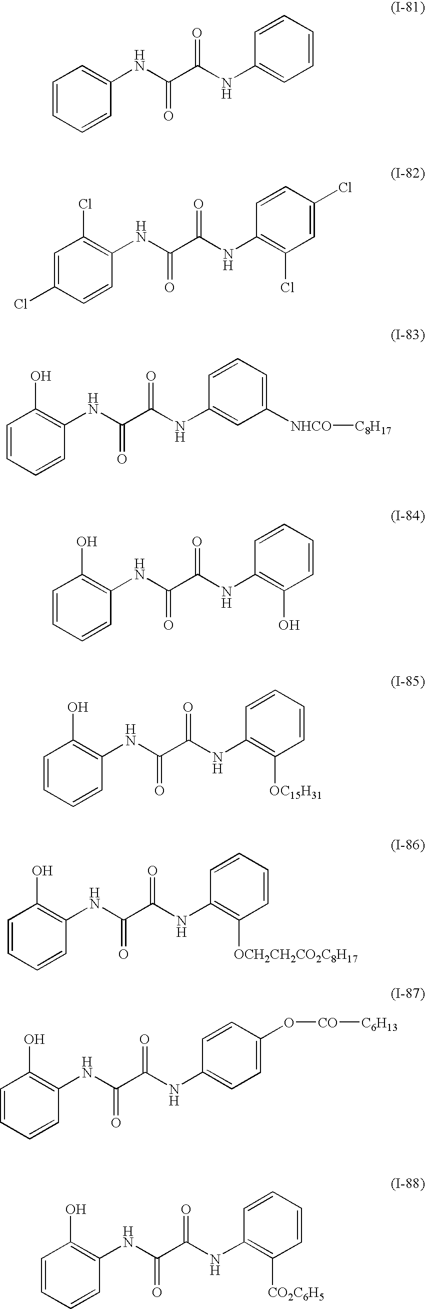

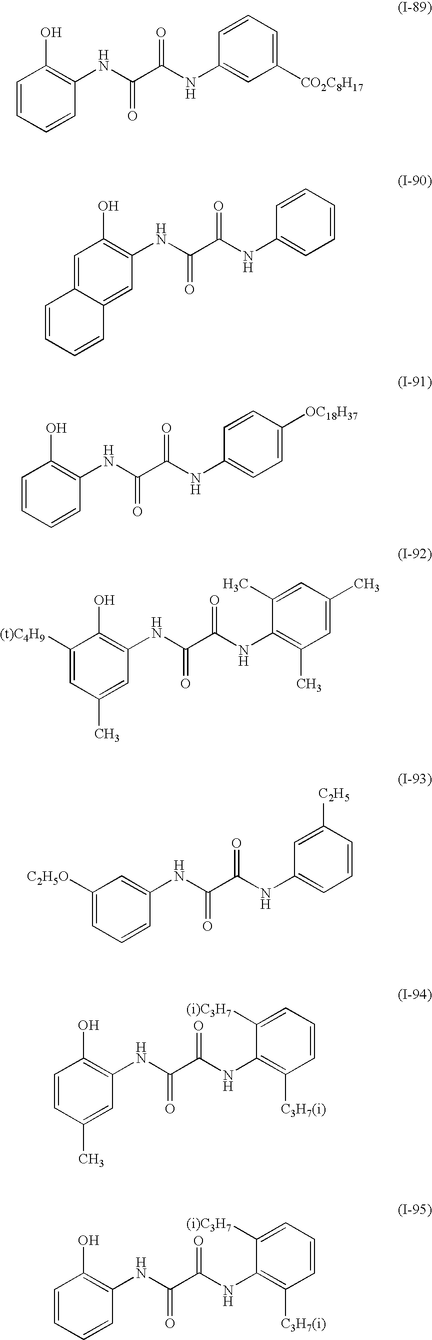

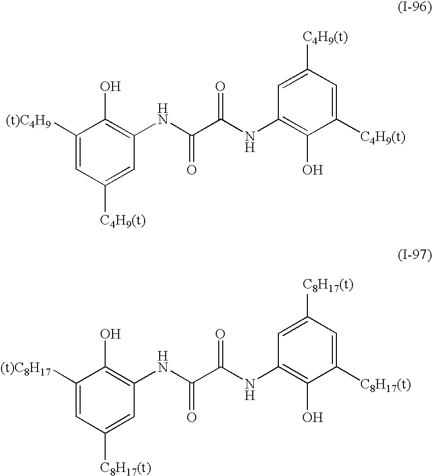

These compounds can be synthesized easily according to the methods described in JP-B No. 50-25337, U.S. Pat. No. 3,785,827, JP-A No. 5-4449, JP-B No. 48-30492, or Journal of Organic Chemistry, vol. 23, p. 1344 (1958) or methods similar to those. The compounds represented by Formula (I-1) are commercially available, for example, under the trade name of “Tinuvin 109” of Ciba Specialty Chemicals.

<Near-Infrared-Absorbing Compound Obtained by Oxidation of a Compound Represented by Formula (II)>

The near-infrared-absorbing compounds according to the invention include the near-infrared-absorbing compounds obtained by oxidation of a compounds represented by the following Formula (IT).

First, the compounds represented by Formula (II) will be described.

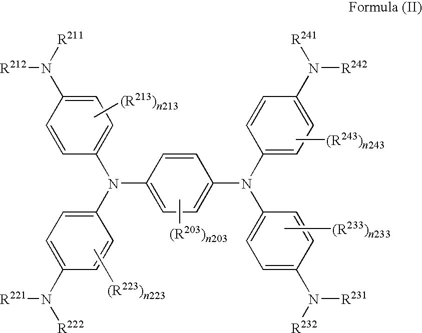

In Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R²⁴³ each independently represent a substituent group; and n²⁰³, n²¹³, n²²³, n²³³ and n²⁴³ each independently denote an integer of 0 to 4.

Each of R²¹¹, R²¹², R²²¹, R²²², R²³¹, R²³², R²⁴¹ and R²⁴² preferably represents a hydrogen atom or an alkyl, alkenyl, alkynyl, or aryl group; more preferably a hydrogen atom, an alkyl group having 1 to 20 carbon atoms, an alkenyl group having 2 to 20 carbon atoms, an alkynyl group having 2 to 20 carbon atoms or an aryl group having 6 to 20 carbon atoms; still more preferably an alkyl group having 1 to 10 carbon atoms, an alkenyl group having 2 to 10 carbon atoms, or an aryl group having 6 to 10 carbon atoms; still more preferably an alkyl group having 1 to 8 carbon atoms or an aryl group having 6 to 8 carbon atoms; and most preferably an alkyl group having 2 to 6 carbon atoms. Favorably, all of R²¹, R²¹², R³²¹, R²²², R²³¹, R²³², R²⁴¹ and R¹⁴² may be the same as each other.

Each of R²⁰³, R²¹³, R²²³, R²³³ and R²⁴³ preferably represents a halogen atom or an alkyl, alkenyl, alkynyl, aryl, cyano, hydroxyl, carboxyl, alkoxy, aryloxy, silyloxy, acyloxy, carbamoyloxy, alkoxycarbonyloxy, aryloxycarbonyloxy, amino, acylamino, aminocarbonylamino, alkoxycarbonylamino, aryloxycarbonylamino, sulfamoylamino, alkyl- or aryl-sulfonylamino, mercapto, alkylthio, arylthio, sulfamoyl, sulfo, alkyl- or aryl-sulfinyl, alkyl or arylsulfonyl, acyl, aryloxycarbonyl, alkoxycarbonyl, carbamoyl, imido, phosphino, phosphinyl, phosphinyloxy, phosphinylamino or silyl group; more preferably a halogen atom or an alkyl, alkenyl, aryl, cyano, hydroxyl, carboxyl, alkoxy, aryloxy, silyloxy, amino, alkylthio, arylthio, imido, or silyl group; still more preferably a halogen atom or an alkyl, aryl, alkoxy, aryloxy, silyloxy, or amino group; and most preferably an alkyl group, Favorably, all of R²¹³, R²²³, R²³³ and R²⁴³ may be the same as each other.

Bach of n²⁰³, n²¹³, n²²³, n²³³ and n²⁴³ is preferably 0 to 3, more preferably 0 to 2, still more preferably 0 or 1, and most preferably 0.

Hereinafter, specific examples of the compounds according to the invention represented by Formula (II) will be listed, however the invention is not limited thereto,

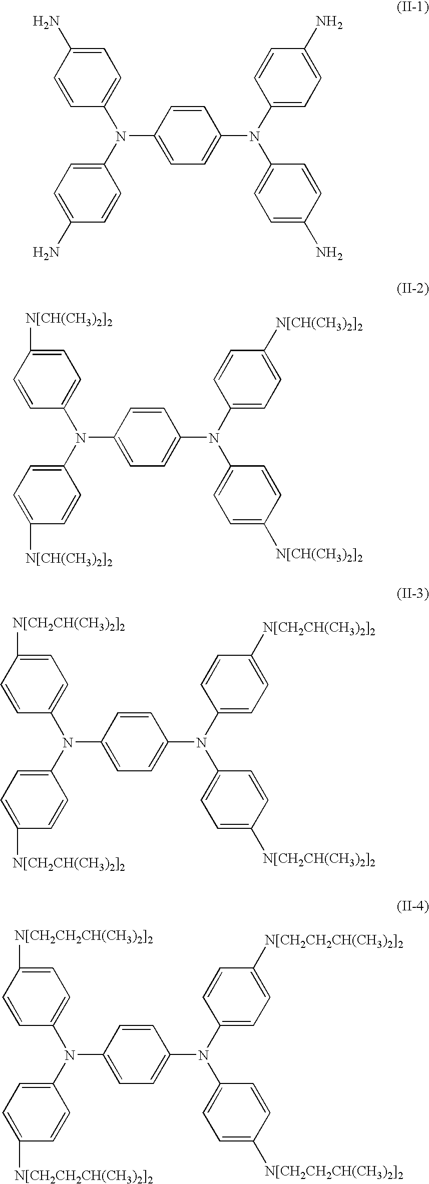

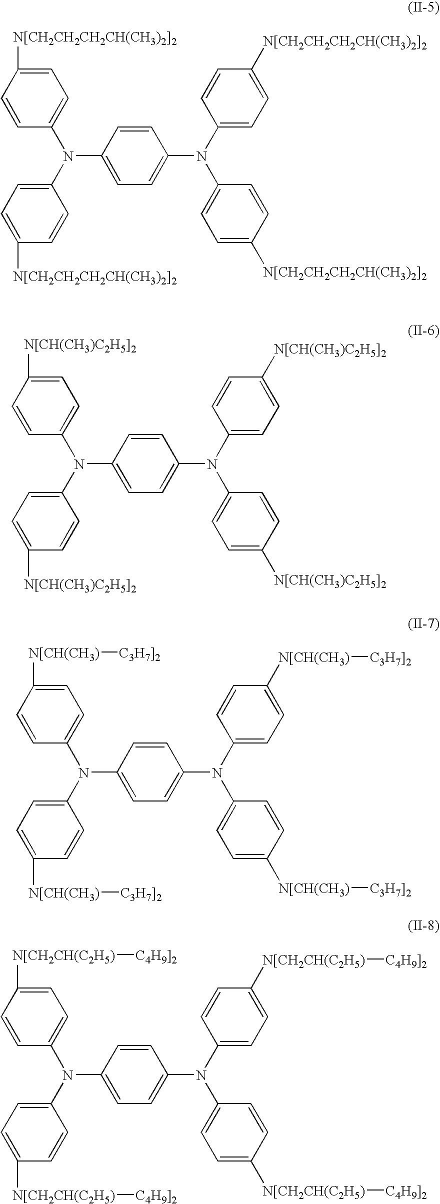

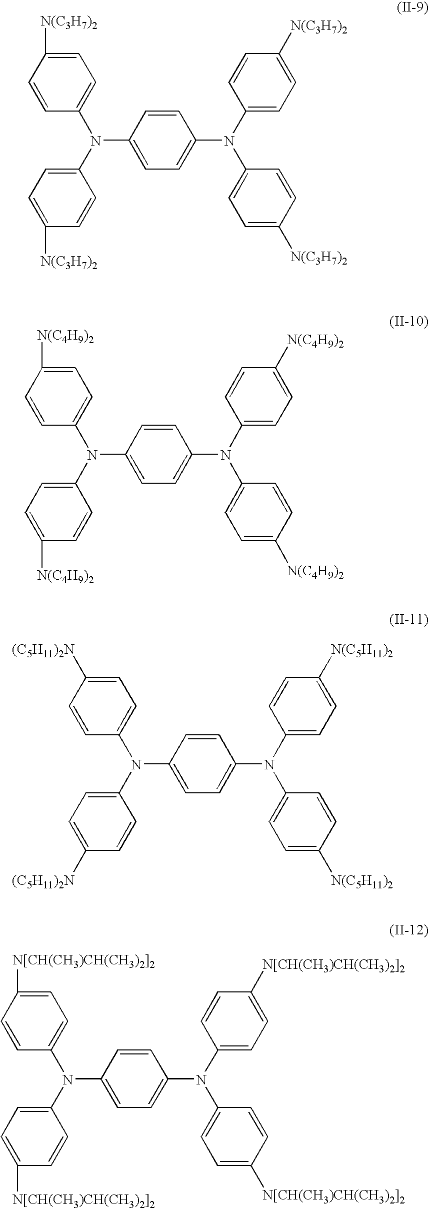

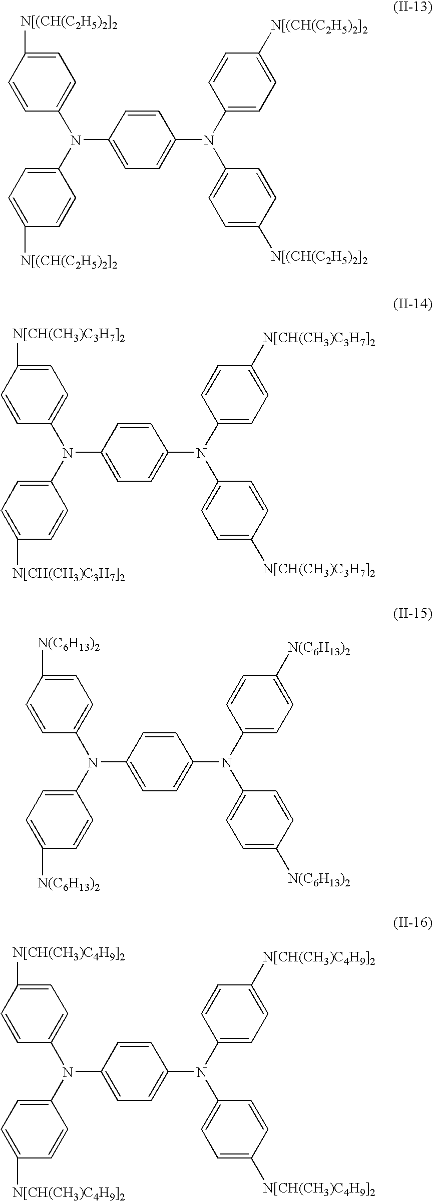

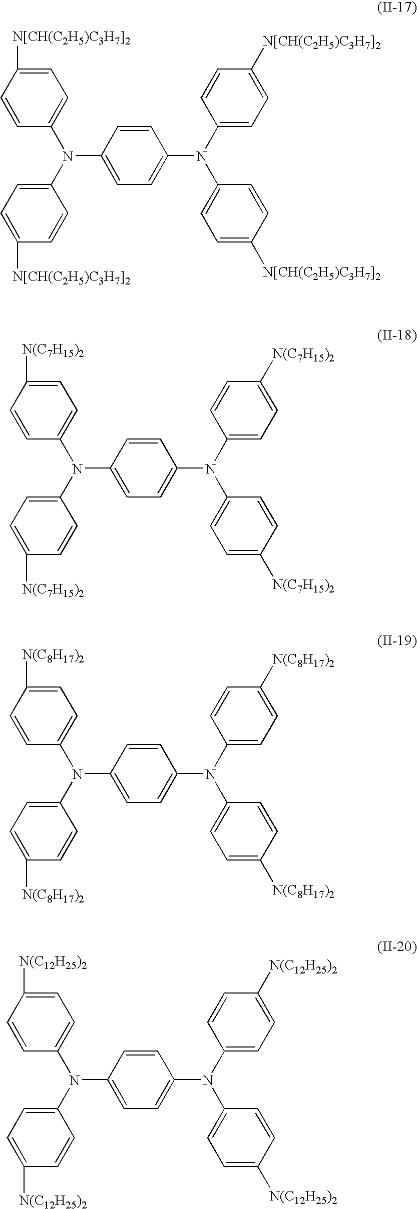

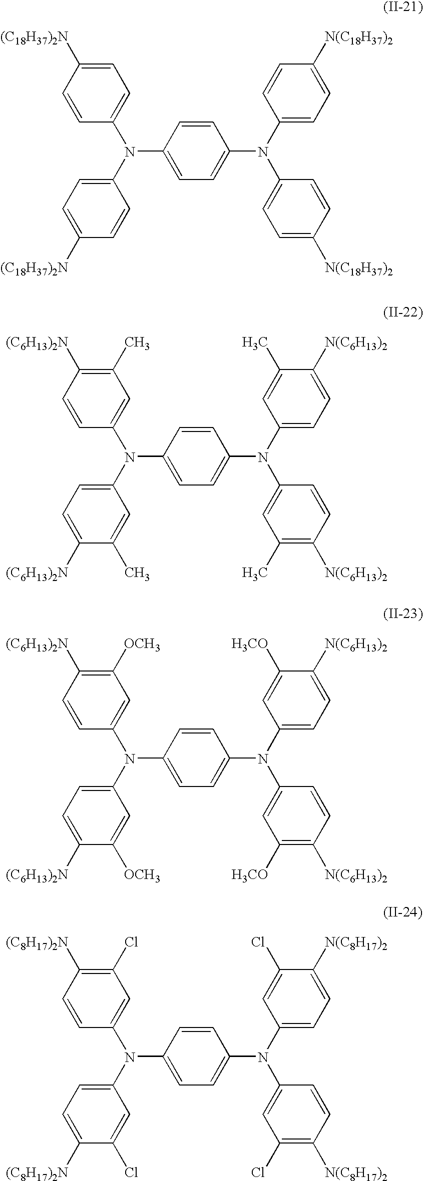

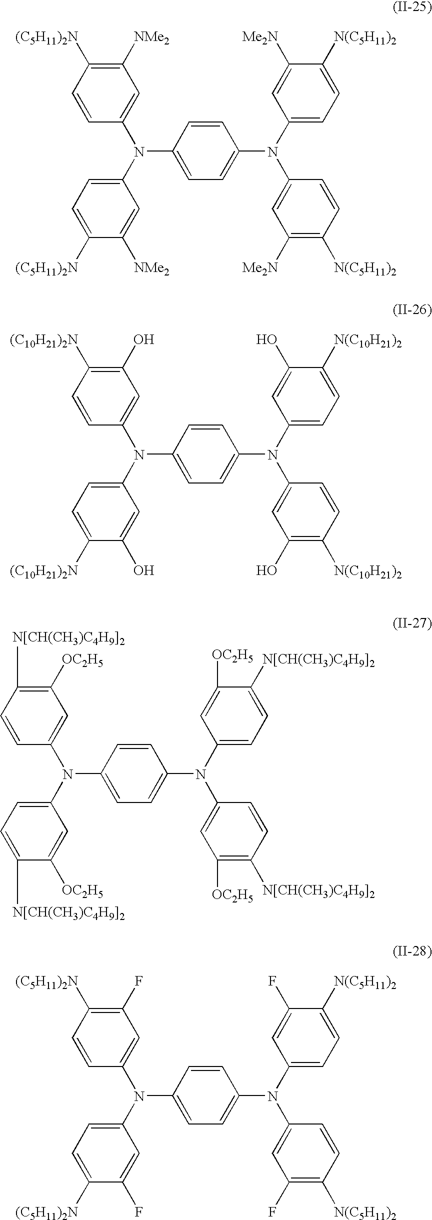

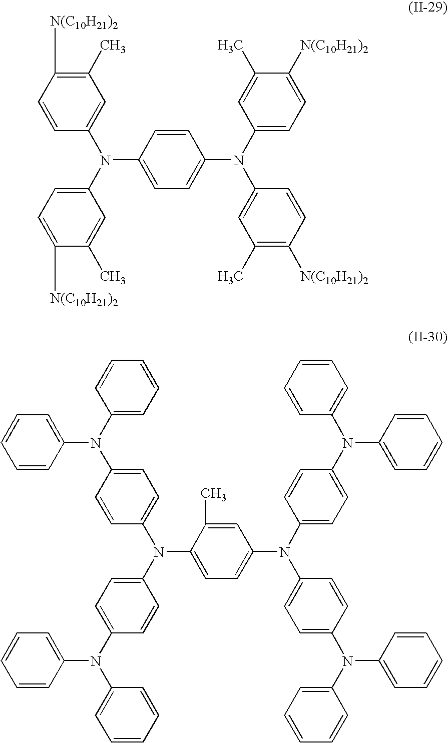

The compounds represented by Formula (II) can be synthesized, for example, according to the methods described in Journal of Dispersion Science and Technology, vol. 23, p. 555 (2002).

The near-infrared-absorbing material according to the invention contains a near-infrared-absorbing compound obtained by oxidation of a compound represented by Formula (II), preferably, an aminium or diimmonium colorant compound obtained by oxidation of the compound represented by Formula (II), and particularly preferably, a compound represented by the following Formula (III-1).

For preparation of the aminium or diimmonium colorant by oxidation of a compound represented by Formula (II), known are, for example, the methods of oxidizing a compound represented by Formula (II) with Cu²⁺ (e.g., JP-B No. 59-40825, JP-A No. 63-51462), oxidizing it with Fe³⁺ (e.g., JP-A No. 2-311447, JP-A No. 11-335054), using an oxidation reaction by a solid catalyst (e.g., JP-A No. 5-98243), oxidizing it with a peroxodisulfate salt (e.g., JP-A No. 2003-55643), oxidizing it with silver hexafluoroantimonate (e.g., Journal of Dispersion Science and Technology, p. 23, 555 (2002)) and oxidizing it electrically (e.g., JP-A No. 61-246391); and these compounds are easily synthesized according to the methods or methods similar thereto.

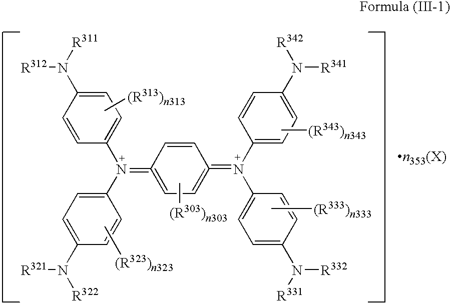

In Formula (III-1), R³¹¹, R³¹², R³²¹, R³²², R³³¹, R³³², R³⁴¹ and R³⁴² each independently represent a hydrogen atom or an aliphatic or aromatic group; R³⁰³, R³¹³, R³²³, R³³³ and R³⁴³ each independently represent a substituent group; n³⁰³, n³¹³, n³²³, n³³³ and n³⁴³ each independently denote an integer of 0 to 4; X represents a monovalent or divalent anion; n³⁵³ is 1 or 2; and the product of the valency of X and n³⁵³ is 2.

R³¹¹, R³¹², R³²¹, R³²², R³³¹, R³³², R³⁴¹ and R³⁴² are the same as R²¹¹ and others described above, and the preferable examples thereof are also the same. Favorably, all of R³¹¹, R³¹², R³²¹, R³²², R³³¹, R³³², R³⁴¹ and R³⁴² may be the same as each other.

R³³³, R³¹³, R³²³, R³³³ and R³⁴³ are the same as R²⁰³ and others described above, and the preferable examples thereof are also the same. Favorably, all of R³¹³, R³²³, R³³³ and R³⁴³ are also the same as each other.

n³⁰¹, n³¹³, n³²³, n³³³ and n³⁴³ are the same as n²⁰³ and others described above, and preferable examples thereof are also the same.

X represents a monovalent or divalent anion; and X preferably represents a perchlorate, carboxylate, sulfonate, hexafluorophosphate, tetrafluoroborate or hexafluoroantimonate ion; more preferably a perchlorate, sulfonate, hexafluorophosphate, tetrafluoroborate or hexafluoroantimonate ion; still more preferably a sulfonate, hexafluorophosphate, tetrafluoroborate or hexafluoroantimonate ion; and still more preferably a hexafluorophosphate, tetrafluoroborate or hexafluoroantimonate ion.

Hereinafter, specific examples of the compounds according to the invention represented by Formula (III-1) are shown below, however the invention is not limited thereto.

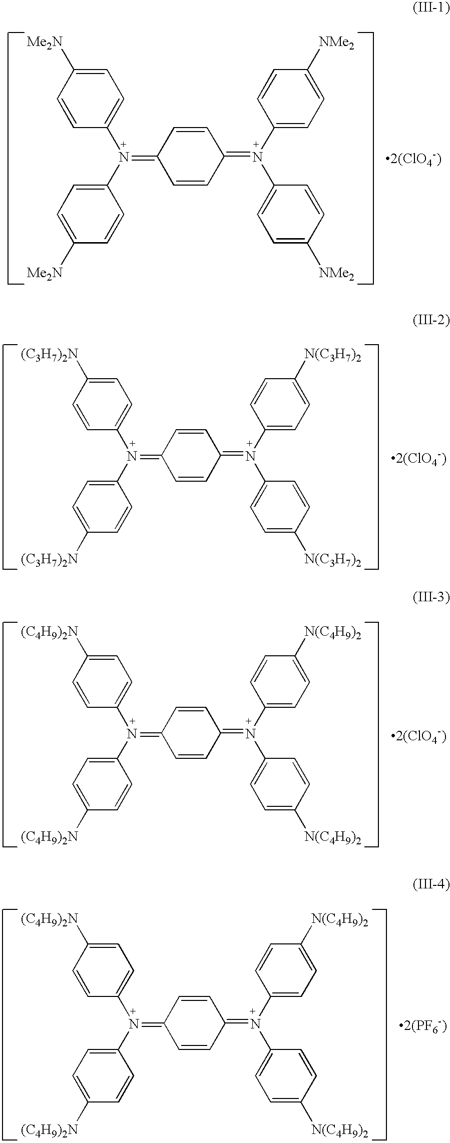

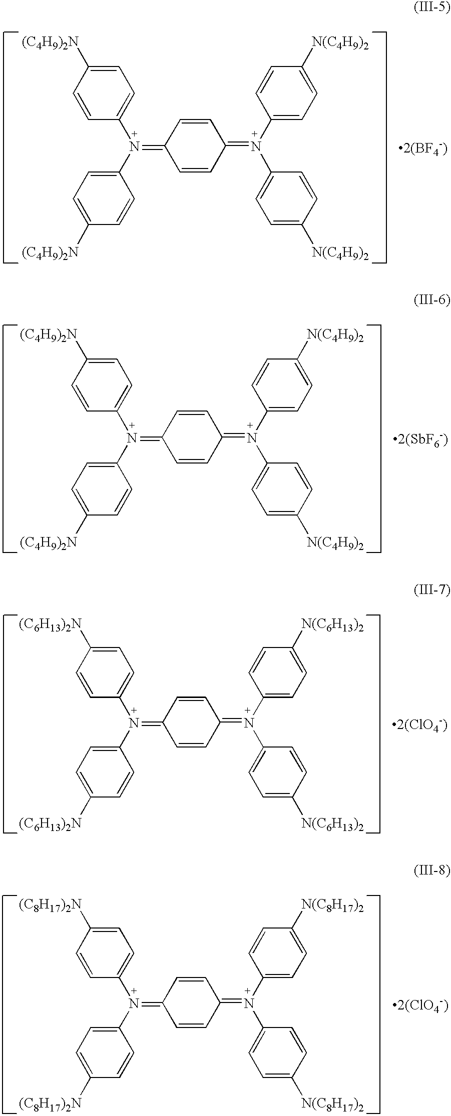

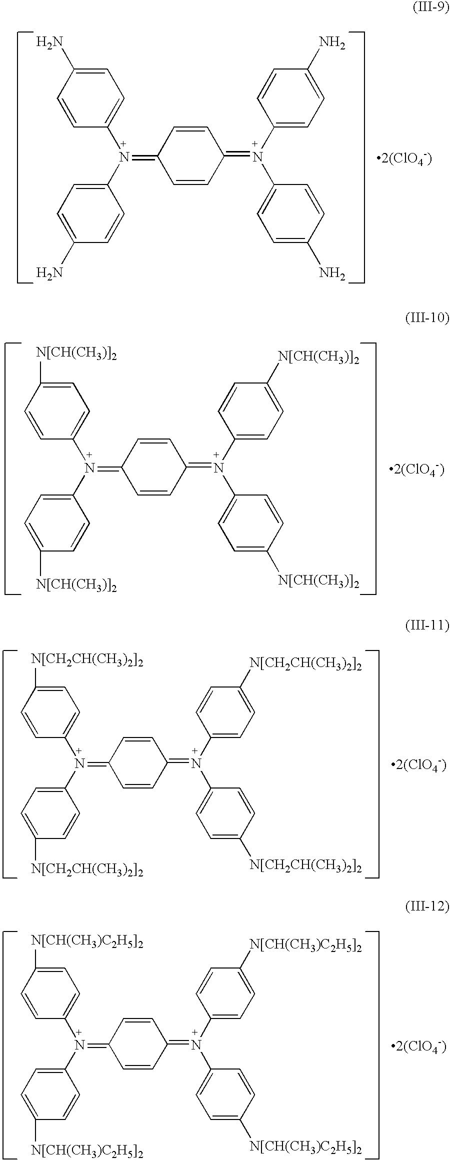

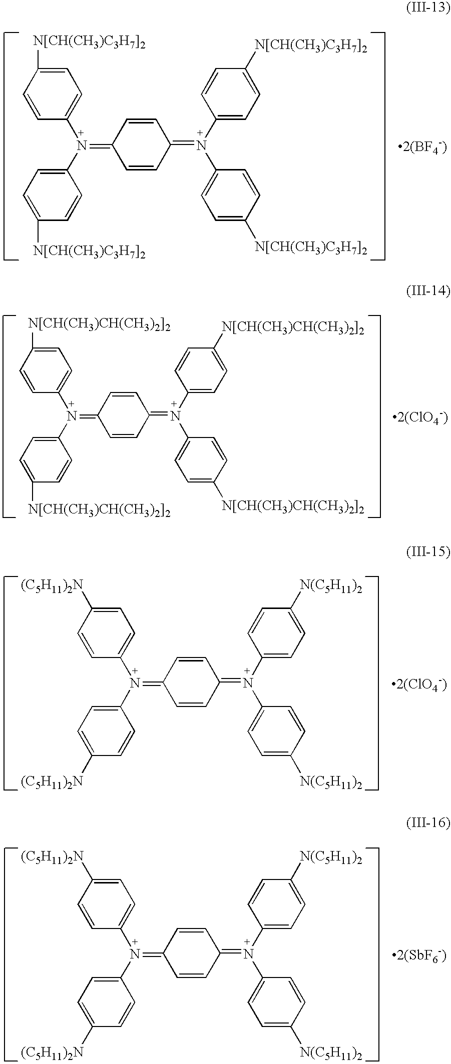

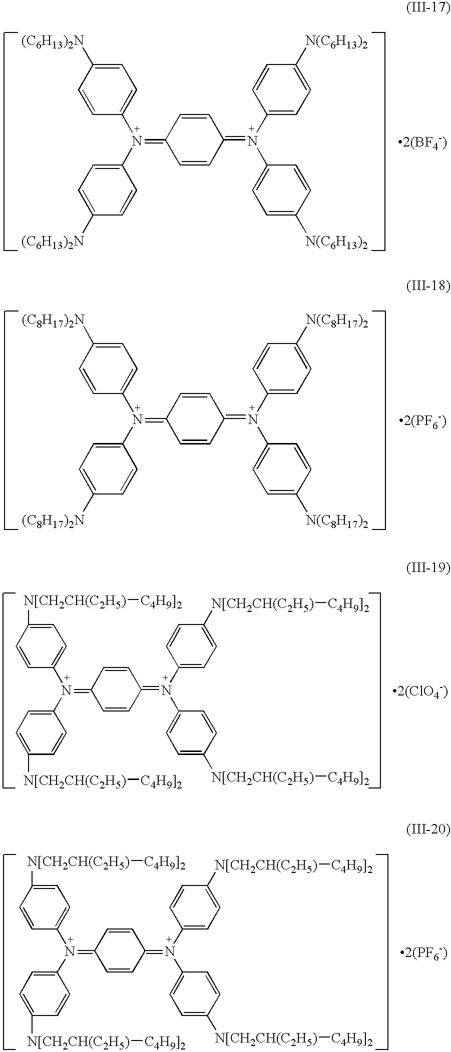

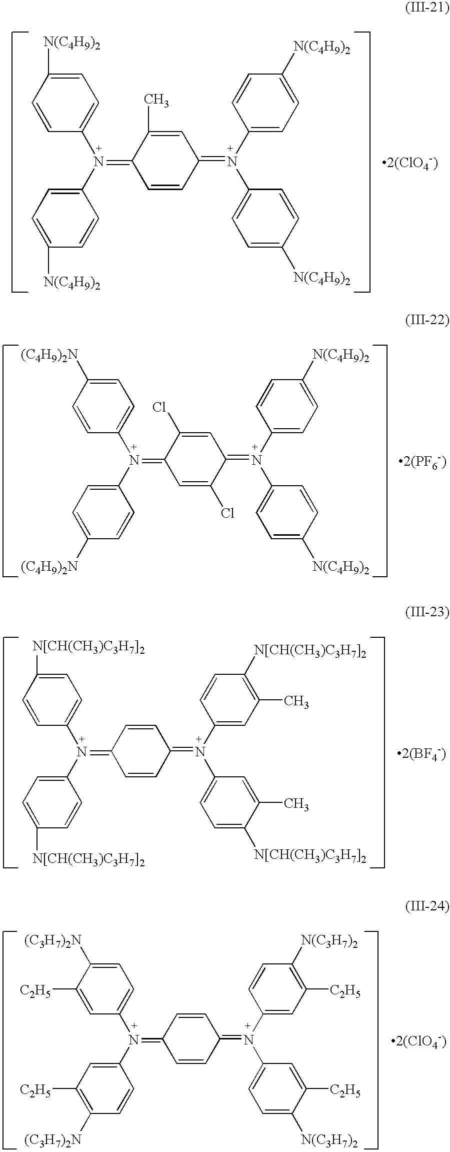

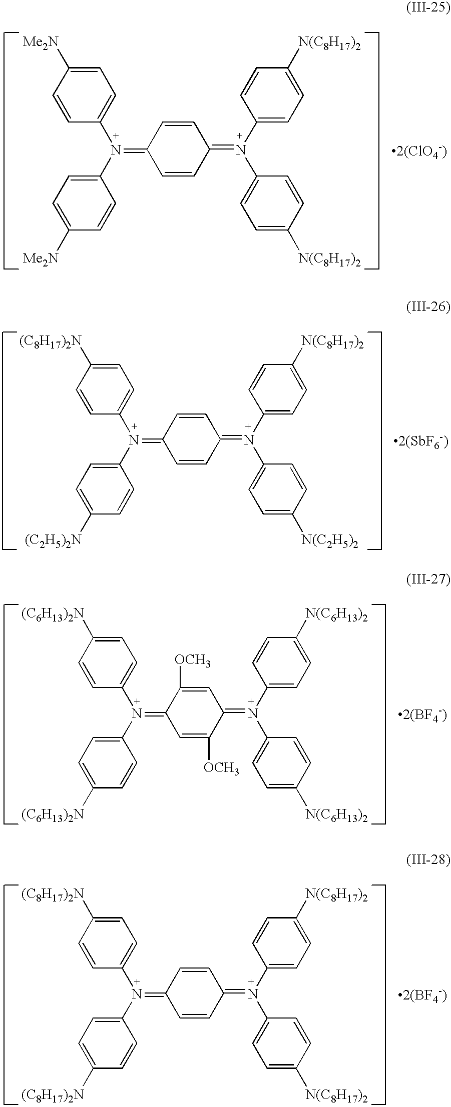

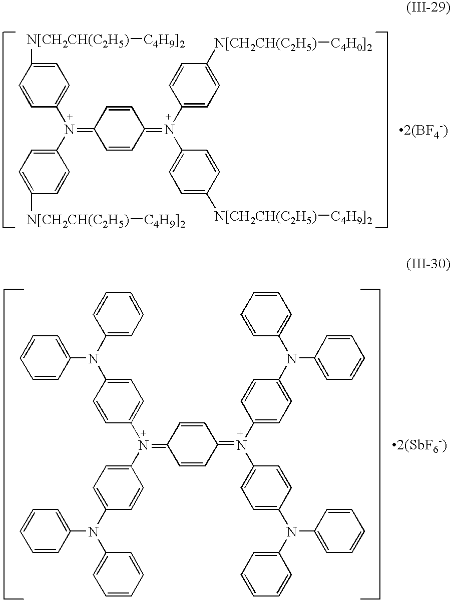

These compounds are synthesized easily according to the preparative methods described above.

<Content Ratio of the Compounds Included in the Near-Infrared-Absorbing Compound According to the Invention>

The total mole number of the compound specified in 1) above is preferably 0.1 mole or more, more preferably 0.1 to 2.0 mole, still more preferably 0.1 to 1.0 mole, and most preferably 0.1 to 0.5 mole, with respect to 1 mole of the colorant compound specified in 2) above.

<<Use of the Near-Infrared-Absorbing Compound According to the Invention>

The near-infrared-absorbing material according to the invention can be used in various applications as a near-infrared-absorbing material, as the compounds defined in 1) and 2) above are coated, blended, hard-coated, or polymerized with a suitable monomer on a substrate such as papers, resin sheets, resins, films, glasses, or metal plates, as they are, in solution, or in combination with a binder and other compounds. Specific applications include optical recording media for long-wavelength laser, recording materials for invisible printing, optical filters, construction and agricultural filters, painting materials, and others. Among them, preferable are applications as optical filters, construction and agricultural filters, painting materials, and others, and more preferable is an application as optical filters.

<Method of Producing the Near-Infrared-Absorbing Compound According to the Invention>

The near-infrared-absorbing material according to the invention is prepared, for example, by dissolving or dispersing the compounds defined in 1) and 2) above in a solvent (e.g., chloroform, methylene chloride, toluene, acetone, methylethylketone, cyclohexanone, ethyl acetate, dibutylether, tetrahydrofuran, or N,N-dimethylformamide), blending them under heat with a resin (e.g., ABS resin, polyethylene resin, polypropylene resin, polyvinyl chloride resin, polycarbonate resin, polystyrene resin, polyacrylonitrile resin, methacrylonitrile resin, polymethacrylic ester resin, or polyester resin), or dissolving them in the solvent, adding the resin thereto additionally and heating the mixture to solubilization; and then forming a thin film by applying the compounds, for example, on a resin film described above, as it is or as dissolved or dispersed in the solvent.

The near-infrared-absorbing compound according to the invention, which is superior both in light resistance and other physical properties, and thus it can be used in various other new applications.

### EXAMPLES

Hereinafter the present invention will be described in detail with reference to Examples, however it should be understood that the invention is not limited thereto.

In the following Examples, two compounds defined in 1) of the invention will be called, for convenience, compounds (I-a) and (I-b), while the compound defined in 2) above, a compound (III).

### Example 1

### Preparation of Near-Infrared-Absorbing Filter

10 g of polystyrene, compounds (I-a) and (I-b) in the structures and amounts shown in the following Tables 1 to 2, and 0.1 g of an exemplary compound (111-6) were added to 100 ml of chloroform; and the mixture was dissolved by stirring at 40° C. for 15 minutes, coated on a glass plate, and dried at room temperature under air stream, to give a sample.

(Light Resistance Test)

The sample obtained was irradiated by a xenon lamp at 95,000 luxes for 3 days; the concentration of the exemplary compound (III-6) at the maximum spectroscopic absorption wavelength was measured before and after irradiation; and the light resistance (light fastness) of the sample was evaluated from the retention rate thus obtained.

TABLE 1

| | Compound (I-a) | | Compound (I-b) | | | |
|---|---|---|---|---|---|---|
| Test | | Molar ratio | | Molar ratio | Light | |
| number | Structure | to (III-6) | Structure | to (III-6) | resistance | Remarks |
| 100 | None | | None | | 0.08 | Comparative Example |
| 101 | (I-9) | 0.05 | None | | 0.12 | Comparative Example |
| 102 | (I-9) | 0.1 | None | | 0.3 | Comparative Example |
| 103 | (I-9) | 0.2 | None | | 0.4 | Comparative Example |
| 104 | (I-9) | 0.4 | None | | 0.42 | Comparative Example |
| 105 | (I-9) | 1 | None | | 0.44 | Comparative Example |
| 106 | None | | (I-14) | 0.05 | 0.11 | Comparative Example |
| 107 | None | | (I-14) | 0.1 | 0.3 | Comparative Example |
| 108 | None | | (I-14) | 0.2 | 0.37 | Comparative Example |
| 109 | None | | (I-I4) | 0.4 | 0.39 | Comparative Example |
| 110 | None | | (I-14) | 1 | 0.4 | Comparative Example |
| 111 | (I-9) | 0.025 | (I-14) | 0.025 | 0.12 | The invention |
| 112 | (I-9) | 0.05 | (I-14) | 0.05 | 0.4 | The invention |
| 113 | (I-9) | 0.1 | (I-14) | 0.1 | 0.46 | The invention |
| 114 | (I-9) | 0.2 | (I-14) | 0.2 | 0.55 | The invention |
| 115 | (I-9) | 0.5 | (I-14) | 0.5 | 0.56 | The invention |
| 116 | None | | (I-18) | 0.05 | 0.1 | Comparative Example |
| 117 | None | | (I-18) | 0.1 | 0.28 | Comparative Example |
| 118 | None | | (I-18) | 0.2 | 0.35 | Comparative Example |
| 119 | None | | (I-18) | 0.4 | 0.4 | Comparative Example |
| 120 | None | | (I-18) | 1 | 0.41 | Comparative Example |
| 121 | (I-9) | 0.025 | (I-18) | 0.025 | 0.12 | The invention |
| 122 | (I-9) | 0.05 | (I-18) | 0.05 | 0.44 | The invention |
| 123 | (I-9) | 0.1 | (I-18) | 0.1 | 0.48 | The invention |
| 124 | (I-9) | 0.2 | (I-18) | 0.2 | 0.51 | The invention |
| 125 | (I-9) | 0.5 | (I-18) | 0.5 | 0.52 | The invention |
| 126 | None | | (I-41) | 0.05 | 0.11 | Comparative Example |
| 127 | None | | (I-41) | 0.1 | 0.2 | Comparative Example |
| 128 | None | | (I-41) | 0.2 | 0.25 | Comparative Example |
| 129 | None | | (I-41) | 0.4 | 0.29 | Comparative Example |
| 130 | None | | (I-41) | 1 | 0.32 | Comparative Example |
| 131 | (I-9) | 0.025 | (I-41) | 0.025 | 0.14 | The invention |
| 132 | (I-9) | 0.05 | (I-41) | 0.05 | 0.55 | The invention |
| 133 | (I-9) | 0.1 | (I-41) | 0.1 | 0.63 | The invention |
| 134 | (I-9) | 0.2 | (I-41) | 0.2 | 0.68 | The invention |
| 135 | (I-9) | 0.5 | (I-41) | 0.5 | 0.7 | The invention |

TABLE 2

| | Compound (I-a) | | Compound (I-b) | | | |
|---|---|---|---|---|---|---|
| Test | | Molar ratio | | Molar ratio | Light | |
| number | Structure | to (III-6) | Structure | to (III-6) | resistance | Remarks |
| 136 | None | | (I-52) | 0.05 | 0.11 | Comparative Example |
| 137 | None | | (I-52) | 0.1 | 0.22 | Comparative Example |
| 138 | None | | (I-52) | 0.2 | 0.26 | Comparative Example |
| 139 | None | | (I-52) | 0.4 | 0.28 | Comparative Example |
| 140 | None | | (I-52) | 1 | 0.34 | Comparative Example |
| 141 | (I-9) | 0.025 | (I-52) | 0.025 | 0.14 | The invention |
| 142 | (I-9) | 0.05 | (I-52) | 0.05 | 0.52 | The invention |
| 143 | (I-9) | 0.1 | (I-52) | 0.1 | 0.6 | The invention |
| 144 | (I-9) | 0.2 | (I-52) | 0.2 | 0.66 | The invention |
| 145 | (I-9) | 0.5 | (I-52) | 0.5 | 0.69 | The invention |
| 147 | None | | (I-71) | 0.1 | 0.18 | Comparative Example |
| 148 | None | | (I-71) | 0.2 | 0.22 | Comparative Example |
| 149 | None | | (I-71) | 0.4 | 0.26 | Comparative Example |
| 150 | None | | (I-71) | 1 | 0.3 | Comparative Example |
| 151 | (I-9) | 0.025 | (I-71) | 0.025 | 0.12 | The invention |
| 152 | (I-9) | 0.05 | (I-71) | 0.05 | 0.48 | The invention |
| 153 | (I-9) | 0.1 | (I-71) | 0.1 | 0.55 | The invention |
| 154 | (I-9) | 0.2 | (I-71) | 0.2 | 0.64 | The invention |
| 155 | (I-9) | 0.5 | (I-71) | 0.5 | 0.66 | The invention |
| 156 | None | | (I-93) | 0.05 | 0.12 | Comparative Example |
| 157 | None | | (I-93) | 0.1 | 0.16 | Comparative Example |
| 158 | None | | (I-93) | 0.2 | 0.2 | Comparative Example |
| 159 | None | | (I-93) | 0.4 | 0.25 | Comparative Example |
| 160 | None | | (I-93) | 1 | 0.27 | Comparative Example |
| 161 | (I-9) | 0.025 | (I-93) | 0.025 | 0.13 | The invention |
| 162 | (I-9) | 0.05 | (I-93) | 0.05 | 0.48 | The invention |
| 163 | (I-9) | 0.1 | (I-93) | 0.1 | 0.55 | The invention |
| 164 | (I-9) | 0.2 | (I-93) | 0.2 | 0.64 | The invention |
| 165 | (I-9) | 0.5 | (I-93) | 0.5 | 0.66 | The invention |

As shown in Tables 1 to 2, the light resistance was more preferable when two or more of the compounds specified in 1) of the invention were used than when only one of them was used in the same total addition amount, and the effect was significantly greater than expected.

### Example 2

### Preparation of Near-Infrared-Absorbing Filter

10 g of polystyrene, compounds (I-a) and (I-b) in the structures and amounts shown in the following Tables 3 to 4, and 0.1 g of an exemplary compound (III) were added to 100 ml of chloroform; and the mixture was dissolved by stirring at 40° C. for 15 minutes, coated on a glass plate, and dried at room temperature under air stream, to give a sample.

(Light Resistance Test)

The sample obtained was irradiated by a xenon lamp at 95,000 luxes for 3 days; the concentration of the exemplary compound (III) at the maximum spectroscopic absorption wavelength was measured before and after irradiation; and the light resistance (light fastness) was evaluated from the retention rate thus obtained.

TABLE 3

| | Compound (I-a) | | Compound (I-b) | | | | |
|---|---|---|---|---|---|---|---|
| | | Molar | | Molar | Compound | | |
| Test | | ratio | | ratio | (III) | Light | |
| number | Structure | to (III) | Structure | to (III) | structure | resistance | Remarks |
| 200 | None | | | | (III-4) | 0.06 | Comparative Example |
| 201 | (I-11) | 0.05 | None | | (III-4) | 0.08 | Comparative Example |
| 202 | (I-11) | 0.1 | None | | (III-4) | 0.15 | Comparative Example |
| 203 | (I-11) | 0.2 | None | | (IH-4) | 0.28 | Comparative Example |
| 204 | (I-11) | 0.4 | None | | (III-4) | 0.33 | Comparative Example |
| 205 | (I-11) | 1 | None | | (III-4) | 0.37 | Comparative Example |
| 206 | None | | (I-41) | 0.05 | (III-4) | 0.07 | Comparative Example |
| 207 | None | | (I-41) | 0.1 | (III-4) | 0.13 | Comparative Example |
| 208 | None | | (I-4I) | 0.2 | (III-4) | 0.24 | Comparative Example |
| 209 | None | | (I-41) | 0.4 | (III-4) | 0.3 | Comparative Example |
| 210 | None | | (I-41) | 1 | (III-4) | 0.33 | Comparative Example |
| 211 | (I-11) | 0.025 | (I-41) | 0.025 | (III-4) | 0.09 | The invention |
| 212 | (I-11) | 0.05 | (I-4I) | 0.05 | (III-4) | 0.35 | The invention |
| 213 | (I-11) | 0.1 | (I-41) | 0.1 | (III-4) | 0.43 | The invention |
| 214 | (I-11) | 0.2 | (I-41) | 0.2 | (III-4) | 0.55 | The invention |
| 215 | (I-11) | 0.5 | (I-41) | 0.5 | (III-4) | 0.62 | The invention |
| 216 | (I-57) | 0.05 | None | | (III-4) | 0.08 | Comparative Example |
| 217 | (I-57) | 0.1 | None | | (III-4) | 0.16 | Comparative Example |
| 218 | (I-57) | 0.2 | None | | (III-4) | 0.3 | Comparative Example |
| 219 | (I-57) | 0.4 | None | | (III-4) | 0.35 | Comparative Example |
| 220 | (I-57) | 0.1 | None | | (III-4) | 0.39 | Comparative Example |
| 221 | (I-57) | 0.025 | (I-41) | 0.025 | (III-4) | 0.08 | The invention |
| 222 | (I-57) | 0.05 | (I-41) | 0.05 | (III-4) | 0.3 | The invention |
| 223 | (I-57) | 0.1 | (I-41) | 0.1 | (III-4) | 0.36 | The invention |
| 224 | (I-57) | 0.2 | (I-41) | 0.2 | (III-4) | 0.42 | The invention |
| 225 | (I-57) | 0.5 | (I-41) | 0.5 | (III-4) | 0.51 | The invention |

TABLE 4

| | Compound (I-a) | | Compound (I-b) | | | | |
|---|---|---|---|---|---|---|---|
| | | Molar | | Molar | Compound | | |
| Test | | ratio | | ratio | (III) | Light | |
| number | Structure | to (III) | Structure | to (III) | structure | resistance | Remarks |
| 226 | None | | None | | (III16) | 0.06 | Comparative Example |
| 227 | (I-18) | 0.05 | None | | (III16) | 0.08 | Comparative Example |
| 228 | (I-18) | 0.1 | None | | (III16) | 0.18 | Comparative Example |
| 229 | (I-18) | 0.2 | None | | (III16) | 0.28 | Comparative Example |
| 230 | (I-18) | 0.4 | None | | (III16) | 0.35 | Comparative Example |
| 231 | (I-18) | 1 | None | | (III16) | 0.4 | Comparative Example |
| 232 | None | | (I-71) | 0.05 | (III16) | 0.1 | Comparative Example |
| 233 | None | | (I-71) | 0.1 | (III16) | 0.18 | Comparative Example |
| 234 | None | | (I-71) | 0.2 | (III16) | 0.22 | Comparative Example |
| 235 | None | | (I-71) | 0.4 | (III16) | 0.26 | Comparative Example |
| 236 | None | | (I-71) | 1 | (III16) | 0.3 | Comparative Example |
| 237 | (I-18) | 0.025 | (I-71) | 0.025 | (III16) | 0.09 | The invention |
| 238 | (I-18) | 0.05 | (I-71) | 0.05 | (III16) | 0.38 | The invention |
| 239 | (I-18) | 0.1 | (I-71) | 0.1 | (III16) | 0.49 | The invention |
| 240 | (I-18) | 0.2 | (I-71) | 0.2 | (III16) | 0.56 | The invention |
| 241 | (I-18) | 0.5 | (I-71) | 0.5 | (III16) | 0.63 | The invention |
| 242 | None | | None | | (III17) | 0.05 | Comparative Example |
| 243 | (I-47) | 0.025 | None | | (III17) | 0.06 | Comparative Example |
| 244 | (I-47) | 0.05 | None | | (III17) | 0.1 | Comparative Example |
| 245 | (I-47) | 0.1 | None | | (III17) | 0.13 | Comparative Example |
| 246 | (I-47) | 0.2 | None | | (III17) | 0.16 | Comparative Example |
| 247 | (I-47) | 0.5 | None | | (III17) | 0.2 | Comparative Example |
| 248 | None | | (I-17) | 0.05 | (III17) | 0.06 | Comparative Example |
| 249 | None | | (I-17) | 0.1 | (III17) | 0.13 | Comparative Example |
| 250 | None | | (I-17) | 0.2 | (III17) | 0.18 | Comparative Example |
| 251 | None | | (I-17) | 0.4 | (III17) | 0.22 | Comparative Example |
| 252 | None | | (I-17) | 1 | (III17) | 0.28 | Comparative Example |
| 253 | (I-47) | 0.025 | (I-17) | 0.025 | (III17) | 0.08 | The invention |
| 254 | (I-47) | 0.05 | (I-17) | 0.05 | (III17) | 0.26 | The invention |
| 255 | (I-47) | 0.1 | (I-17) | 0.1 | (III17) | 0.32 | The invention |
| 256 | (I-47) | 0.2 | (I-I7) | 0.2 | (III17) | 0.4 | The invention |
| 257 | (I-47) | 0.5 | (I-17) | 0.5 | (III-17) | 0.48 | The invention |

As shown in Tables 3 to 4, the results of studies with various different compounds (III) also showed that combined use of two or more compounds specified in 1) above was more preferable in light resistance and greater in its effect than single use of a compound specified in 1) above at the total same addition mole number. Such a significant effect was unpredicted.

The physical property values of the compounds used in Examples of the invention are shown below.

TABLE 5

| Compound | λ Max (ε) | | Measurement solvent |
|---|---|---|---|
| I-9 | 349 nm | (1.52 × 104) | Ethyl acetate |
| I-11 | 348 nm | (1.67 × 104) | Ethyl acetate |
| I-14 | 348 nm | (1.66 × 104) | Ethyl acetate |
| I-17 | 338 nm | (1.59 × 104) | Ethyl acetate |
| I-18 | 339 nm | (1.62 × 104) | Ethyl acetate |
| I-41 | 351 nm | (1.91 × 104) | Ethyl acetate |
| I-47 | 353 nm | (2.01 × 104) | Ethyl acetate |
| I-52 | 308 nm | (4.70 × 103) | N,N-Dimethylformamide |
| I-57 | 309 nm | (4.30 × 103) | N,N-Dimethylformamide |
| I-71 | 299 nm | (1.28 × 104) | Ethyl acetate |
| I-93 | 297 nm | (1.45 × 104) | Ethyl acetate |
| II-1 | 924 nm | | Sulfuric acid |
| II-4 | 843 nm | | Tetrahydrofuran |
| II-10 | 842 nm | | Tetrahydrofuran |
| II-32 | 828 nm | | Tetrahydrofuran |

1-12. (canceled)

13. A process of producing a near-infrared-absorbing film material comprising the steps of, in order, dissolving in a solvent (a) at least two selected from the group consisting of the compounds having a maximum spectroscopic absorption wavelength in solution equal to or less than 470 nm in a wavelength range from 270 to 1,600 nm, (b) a near-infrared-absorbing colorant which is an oxidation product of a compound represented by Formula (II) below and (c) a resin, to form a solution; forming a film of said solution; and drying said film of the solution, thereby forming the film material; 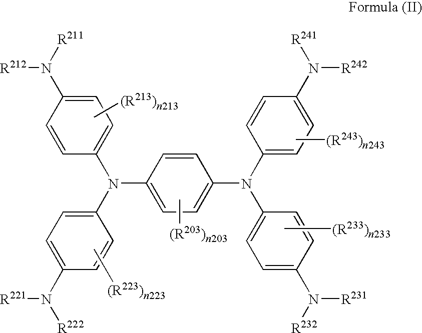
wherein, in Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R²⁴³ each independently represent a substituent group; and n²⁰³, n²¹³, n²²³, n²³³ and n²⁴³ each independently represent an integer of 0 to 4.

14. The process of claim 13, wherein the maximum spectroscopic absorption wavelength is 430 nm or less.

15. The process of claim 14, wherein the maximum spectroscopic absorption wavelength is 410 nm or less.

16. The process of claim 15, wherein the maximum spectroscopic absorption wavelength is 380 nm or less.

17. A process of producing a near-infrared-absorbing film material comprising the steps of, in order, dissolving in a solvent (a) at least two ultraviolet-absorbing compounds, (b) a near-infrared-absorbing colorant which is an oxidation product of a compound represented by Formula (II) below and (c) a resin, to form a solution; forming a film of said solution; and drying said film of the solution, thereby forming the film material; 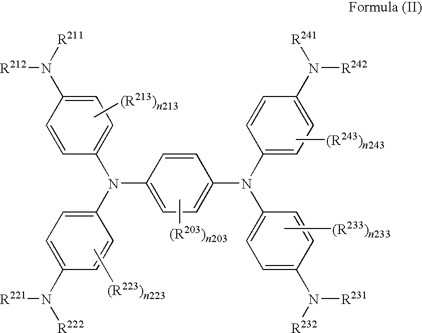
wherein, in Formula (II), R²¹¹, R²¹², R²²¹, R²²², R²³¹, R²³², R²⁴¹ and R²⁴² each independently represent a hydrogen atom or an aliphatic or aromatic group; R²⁰³, R²¹³, R²²³, R²³³ and R³⁴³ each independently represent a substituent group; and n²⁰³, n²¹³, n²²³, n²³³ and n²⁴³ each independently represent al integer of 0 to 4.

18. The process of claim 13, wherein the at least two selected from the group consisting of the compounds having a maximum spectroscopic absorption wavelength in solution equal to or less than 470 nm in a wavelength range from 270 to 1,600 nm and the near-infrared-absorbing colorant are present in a single layer.

19. The process of claim 13, wherein the at least two selected from the group consisting of the compounds having a maximum spectroscopic absorption wavelength in solution equal to or less than 470 nm in a wavelength range from 270 to 1,600 nm are two compounds different in structure selected from compounds represented by the following Formulae (I-1), (I-2), (I-3), (I-4) and (I-5): 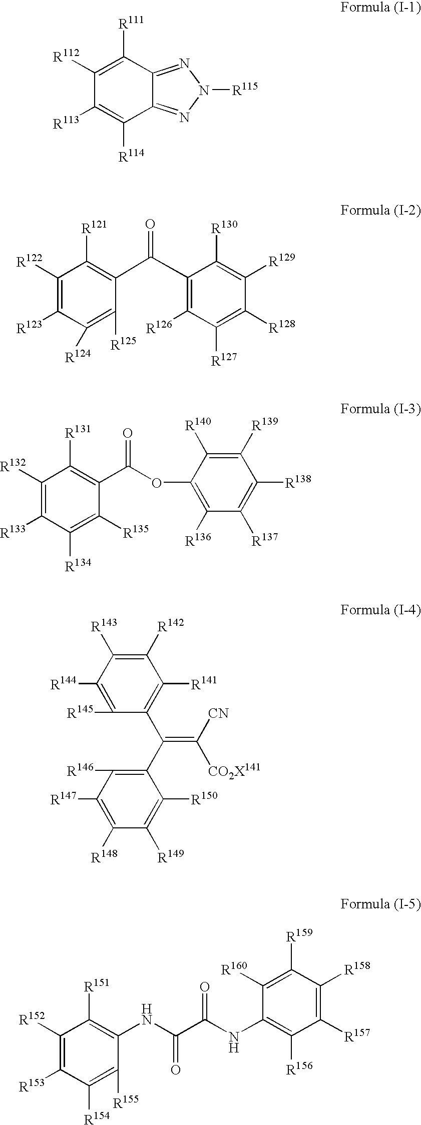
wherein R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰ each independently represent a hydrogen atom or a substituent group; R¹¹⁵ represents a hydrogen atom, an aliphatic group, an aromatic group, or a heterocyclic group binding at its carbon atom; X¹⁴¹ represents a hydrogen atom, an aliphatic group, an aromatic group, or a heterocyclic group binding at its carbon atom; and among R¹¹¹ to R¹¹⁴, R¹²¹ to R¹³⁰, R¹³¹ to R¹⁴⁰, R¹⁴¹ to R¹⁵⁰, and R¹⁵¹ to R¹⁶⁰, two neighboring substituent groups on a benzene ring in each Formula may bind to each other, forming a ring.

20. The process of claim 19, wherein at least two of the at least two selected from the group consisting of the compounds having a maximum spectroscopic absorption wavelength in solution equal to or less than 470 nm in a wavelength range from 270 to 1,600 nm are compounds respectively selected from different formulae among Formulae (I-1), (I-2), (I-3), (I-4) and (I-5).

21. The process of claim 19, wherein at least one of the at least two selected from the group consisting of the compounds having a maximum spectroscopic absorption wavelength in solution equal to or less than 470 nm in a wavelength range from 270 to 1,600 nm is a compound represented by Formula (I-1).

22. The process of claim 19, wherein at least one of the at least two compounds is a compound represented by any one of Formulae (I-2), (I-3), (I-4) and (I-5).

23. The process of claim 13, wherein the total mole number of the at least two selected from the group consisting of the compounds having a maximum spectroscopic absorption wavelength in solution equal to or less than 470 nm in a wavelength range from 270 to 1,600 nm is 0.1 mole or more with respect to 1 mole of the near-infrared-absorbing colorant compound.

24. The process of claim 13, wherein the near-infrared-absorbing colorant is a diimmonium salt represented by the following Formula (III-1): 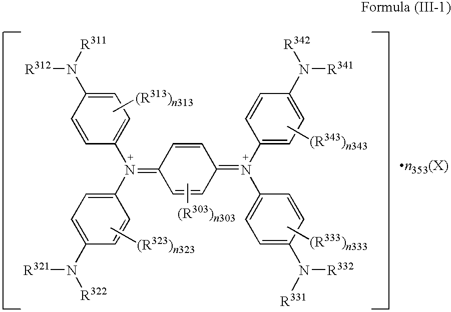
wherein, in Formula (III-1), R³¹¹, R³¹², R³²¹, R³²², R³³¹, R³³², R³⁴¹ and R³⁴² each independently represent a hydrogen atom or an aliphatic or aromatic group; R³⁰³, R³¹³, R³²³, R³³³ and R³⁴³ each independently represent a substituent group; and n³⁰³, n³¹³, n³²³, n³³³ and n³⁴³ each independently represent an integer of 0 to 4; X represents a monovalent or divalent anion; n³⁵³ is 1 or 2; and the product of the valency of X and n³⁵³ is 2.
